(19) United States
(12) Patent Application Publication
(10) Pub. No.: US 2003/0184961 A1
(43) Pub. Date: Oct. 2, 2003

(54) Computer case

(76) Inventor: Hwi Ahn, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/221,741

(22) PCT Filed: Mar. 15, 2001
(86) PCT No.: PCT/KR01/00412

(30) Foreign Application Priority Data
Mar. 15, 2000 (KR) 2000-13034
Jul. 7, 2000 (KR) 2000-38799

(51) Int. Cl. G06F 1/16

(52) U.S. Cl. 361/683; 361/679; 361/741

(57) ABSTRACT

A computer case accommodating hardware devices which is secured thereto. The computer case has a base, two side supports, front and rear panels, a cover. A main circuit board of the computer is laid on the base. The supports extend along a direction substantially perpendicular to the base. The front and rear panels are positioned on the front and rear of the base, respectively. The cover covers the internal devices of the computer. Each structure is configurated to have a uniform sectional shape.

### TECHNICAL FIELD

The present invention relates to a computer case, and more particularly, a computer case to which various kinds of hardware devices including a main circuit board, a storage device such as a HDD, a FDD and an optical disk drive, and a power supply are fixed and in which these hardware devices are accommodated.

### BACKGROUND ART

Various kinds of hardware devices including a main circuit board (main board), a storage device such as a HDD, a FDD, a CD-ROM drive and a DVD, and a power supply are generally fixed to and accommodated in a computer case. A computer case for a common desktop computer includes a frame for fixing hardware devices, and an outer housing connected to the frame which forms the external appearance by surrounding the inner frame.

The frame constitutes a base and a rear surface of a main body, and an inner skeletal structure. Typically, the frame consists of a plurality of parts which are formed by cutting a steel sheet and bending it in a desired shape. These parts are assembled by welding them to each other or by fastening them with screws. They are also designed to have sufficient structural strength since various kinds of hardware devices are secured thereon.

The outer housing constitutes a front surface, a top plane surface and left and right side surfaces of the main body. The part constituting the top plane surface and the left and right side surfaces is manufactured in a single member by cutting and bending a steel sheet. The part covering the front surface is manufactured by injection molding of plastics. These parts are fixed to the frame to define the housing in which various hardware devices are accommodated.

### SUMMARY OF INVENTION

An object of the present invention is to provide a computer case which is comprised of a plurality of parts, each of which has a uniform shape in its section and which can be manufactured by means of a method for processing a metal material by passing it through an outlet of a die, such as extrusion molding.

Another object of the present invention is to provide a computer case structure for facilitating heat dissipation by adding heat-dissipating fins to an outer wall.

A further object of the present invention is to provide a computer case for reducing noise emission to the outside, by providing an inner wall with a structure capable of absorbing interior noise.

A still further object of the present invention is to provide a computer case which is compact when assembled, easy to transport and is able to be carried with a person.

The computer case of the present invention includes a plurality of components. Each of the components has a uniform shape in its section taken in a direction perpendicular to the lengthwise direction. The structure constructed as such can be manufactured by a processing method such as extrusion molding of a metal material such as aluminum.

Specifically, according to one aspect of the present invention, there is provided a computer case with hardware devices for a computer accommodated in and fixed to the computer case, comprising a bottom base having a main board for the computer placed thereon and having a substantially uniform sectional shape; a first support disposed at one side of the bottom base, extending in a direction substantially perpendicular to the bottom base, and having a substantially uniform sectional shape; a second support disposed at the other side of the bottom base, extending in a direction substantially perpendicular to the bottom base, and having a substantially uniform sectional shape; a front panel disposed in the front of the bottom base; a rear panel disposed in the rear of the bottom base; and an upper cover facing the bottom base and covering a top face of the computer case.

### BRIEF DESCRIPTION OF DRAWING

The features of the present invention, together with the above and other objects thereof, can be easily and clearly understood by a person having an ordinary skill in the art upon reading embodiments of the present invention described with reference to the accompanying drawings.

FIG. 1 is a perspective view of a computer case according to a first embodiment of the present invention, with an upper cover thereof disassembled.

FIG. 2 is an exploded perspective view of the computer case shown in FIG. 1.

FIG. 3 are views showing sectional shapes of major parts of the computer case, wherein (a) shows a sectional view of a main body, (b) shows a sectional view of a partition, (c) shows a sectional view of a mounting structure, and (d) shows a sectional view of a front panel.

FIG. 4 is a perspective view which shows various computer hardware devices installed in the computer case shown in FIG. 1, with the upper cover and the front panel removed for showing the interior of the computer case.

FIG. 5 shows methods for coupling a main board in the computer case shown in FIG. 1.

FIG. 6 is a perspective view of a computer case according to a modification of the first embodiment.

FIG. 7 is a sectional view of a main body of the computer case shown in FIG. 6.

FIG. 8 is a perspective view of a computer case according to a second embodiment, with a display device stood vertically while the computer is laid on its side.

FIG. 9 is a perspective view of the computer case shown in FIG. 8, with the computer stood vertically.

FIGS. 10 to 12 are perspective views of the computer case shown in FIG. 8, with an upper cover and connecting bars removed.

FIGS. 13 to 15 are exploded views of the computer case shown in FIG. 8.

FIG. 16 is a front view showing a partially assembled computer case shown in FIG. 8, with the connecting bars and an airflow-guiding member removed.

FIG. 17 shows sections of parts constituting the computer case shown in FIG. 8.

FIG. 18 is a sectional view showing the constitution of a hinge device for rotating the display device, which is installed on the computer case shown in FIG. 8, over 180 degrees.

FIG. 19 is a perspective view showing hardware devices such as a main board, installed in the computer case shown in FIG. 8, with the interior of the computer case shown.

FIGS. 20 and 21 are perspective views of a computer case according to a third embodiment of the present invention, with a cover removed for showing the interior thereof.

FIGS. 22 to 24 are exploded perspective views of the computer case shown in FIG. 20.

FIG. 25 is a front view showing an assembled state of the computer case shown in FIG. 20.

FIG. 26 shows sectional shapes of major structures of the computer case shown in FIG. 20.

FIGS. 27 to 29 are perspective views showing assembled states in the process of assembling the computer case shown in FIG. 20.

FIG. 30 is a perspective view showing a rear panel of the computer case shown in FIG. 20.

FIGS. 31 and 32 are a perspective view and a sectional view respectively, showing the constitution for opening and closing the upper cover of the computer case shown in FIG. 20.

FIG. 33 is a perspective view of a computer case according to a fourth embodiment of the present invention.

FIGS. 34 and 35 are perspective view showing the interior of the computer case shown in FIG. 33.

FIG. 36 is an exploded perspective view of the computer case shown in FIG. 33.

FIG. 37 is a front view showing an assembled computer case shown in FIG. 33.

FIG. 38 shows sections of the major structures of the computer case shown in FIG. 33.

FIG. 39 is a perspective view showing a coupled edge member of the computer case shown in FIG. 33.

FIG. 40 is a perspective view showing an assembled rear panel of the computer case shown in FIG. 33.

### DETAILED DESCRIPTION OF THE EMBODIMENTS

Cases for a desktop computer are generally classified into two types: a first type (those which are laid on their side) having a width larger than its height, and a second type (those which stand vertically) having a height larger than its width. In addition, there is another type capable of being both laid on their side and stood vertically. A computer case of the present invention can be applied to both the type capable of being laid on its side and the type capable of being stood vertically. Therefore, for unifying the technical terms herein, regardless of the placement of the computer case, the side on which a main circuit board (main board) of a computer is installed will be referred to as a “base,” both sides of the base will be referred to as “supports,” and the side opposite the base will be referred to as a “cover.”

First Embodiment

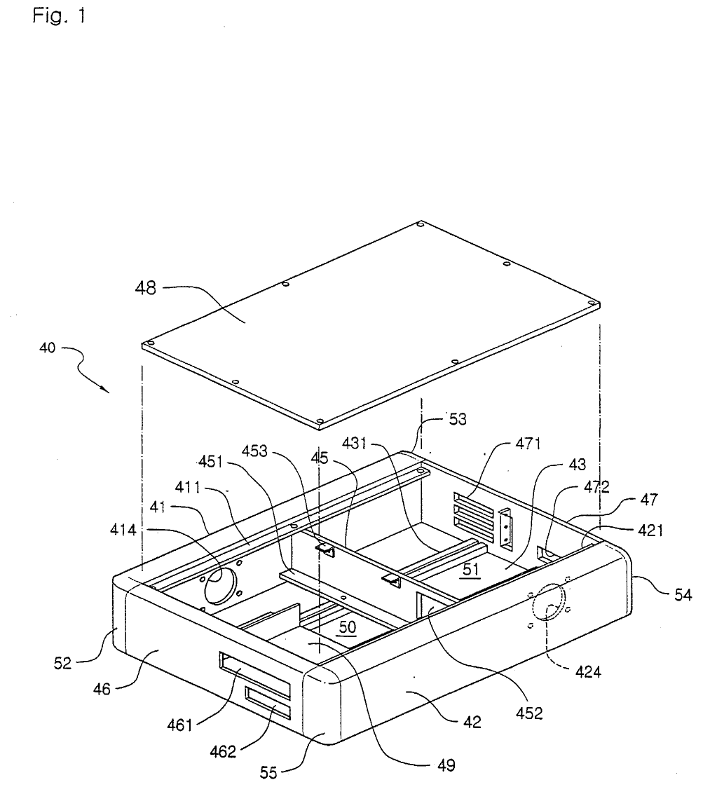

Referring to FIGS. 1 to 3, a computer case 40 according to a first embodiment of the present invention includes a main body 44 integrally provided with a base 43 at the bottom thereof, and left and right supports 41, 42 placed on both sides of the base. The computer case 40 further includes a partition 45 extending laterally for separating the interior of the main body 44 into front and rear portions, a front panel 46, a rear panel 47, au upper cover 48, and a mounting structure 49.

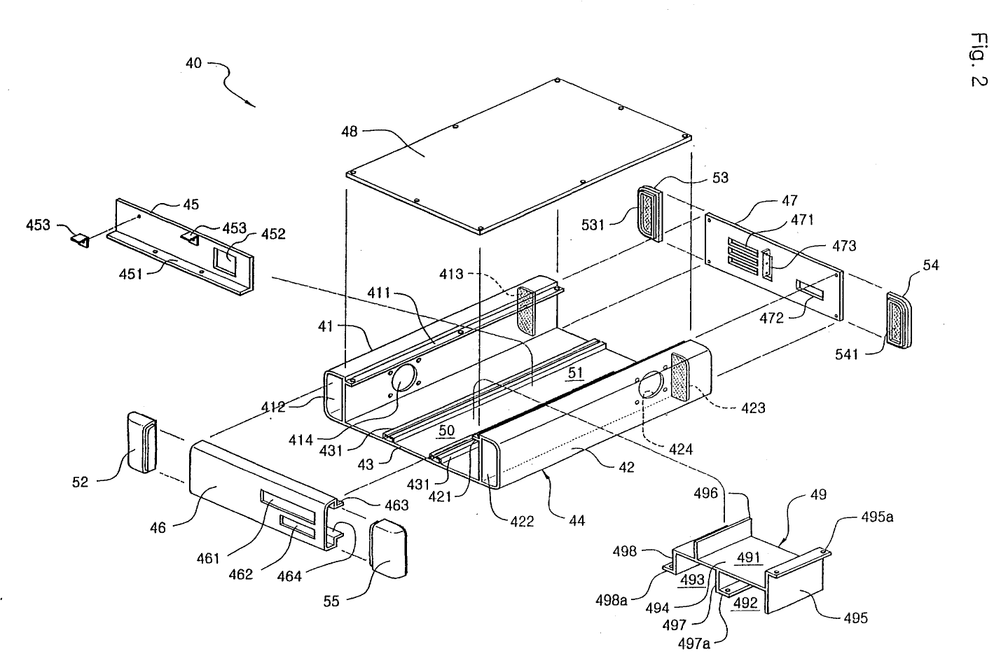

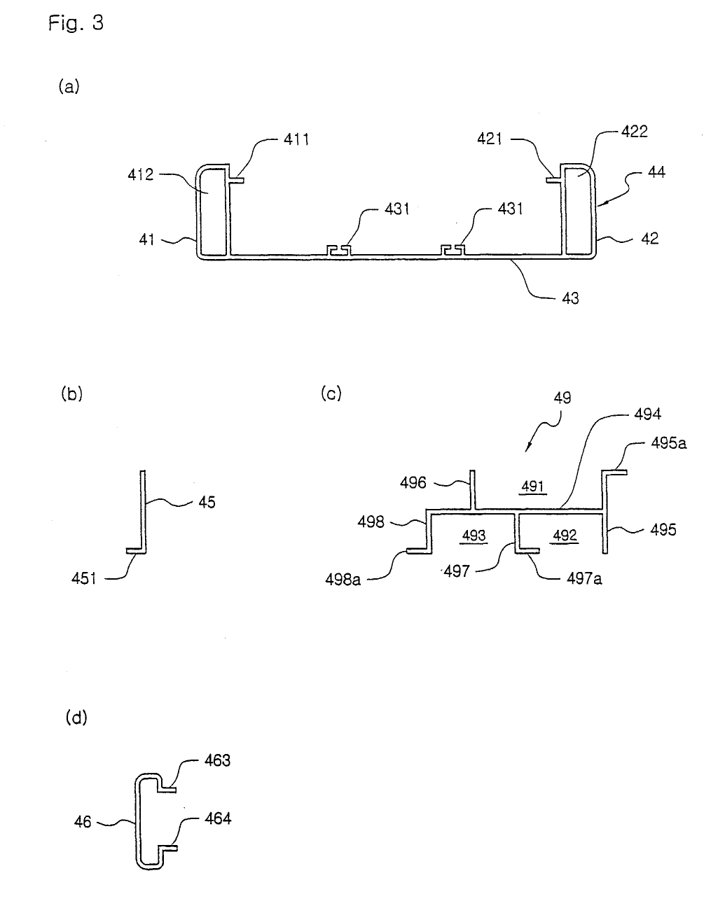

As shown in FIGS. 2 and 3, the main body 44 has a substantially uniform shape in its section in a fore-and-aft direction. The base 43 of the main body 44 is formed with two fixing rails 431 extending in the fore-and-aft direction.

The left and right supports 41, 42 are formed with passages 412, 422 serving as passages for circulating air in the fore-and-aft direction, respectively. Sound-absorbing materials 413, 423 for absorbing noise are installed at inner portions in the vicinity of rear ends of the air-circulating passages 412, 422, respectively. Opposite side surfaces of the left and right supports 41, 42 are formed with apertures 414, 424 for communicating with the interior of the computer, respectively. As shown in the figures, the communicating aperture 414 in the left support 41 is positioned toward the front, whereas the communicating aperture 424 in the right support 42 is positioned toward the rear. Projections extend opposite each other in the vicinity of top ends of the left and right supports 41, 42 to provide stepped portions 411, 421 on which the upper cover 48 is mounted and assembled.

In manufacturing the main body 44 constructed as such, aluminum or aluminum alloy is first processed by means of extrusion molding to give a sectional shape as shown in FIG. 3(a). As shown in FIG. 2, the sound-absorbing materials 413, 423 are fitted into the air-circulating passages 412, 422. The manufacturing of the main body 44 is finished by forming the communicating apertures 414, 424 and assembly screw holes. The edges of the left and right supports 41, 42 are rounded.

The rails 431 are positioned on an upper surface of the base 43. Vertical portions 431a protrude from the upper surface to extend in the lengthwise direction. At tip portions of the vertical portions 431a, horizontal portions 431b are bent perpendicularly with respect to the vertical portions 431a and extend in a direction opposite each other. Opposite ends 431c are spaced apart from each other with a predetermined gap. A method for fixing various kinds of parts by using the rails 431 will be described later.

Referring to FIGS. 1 and 2, the partition 45 is assembled between both the supports and on the base 43 to separate an inner space of the computer into front and rear portions. The position of the partition is determined by considering the size of the main circuit board. Accordingly, the interior of the computer is partitioned into a first chamber 50 and a second chamber 51. The partition 45 has a fixing brace 451 formed at a lower end so that it can be fixed to the rails 431 of the main body 44. A passage aperture 452 through which the first and second chambers 50, 51 can communicate with each other and cables for connecting devices installed in the first and second chambers 50, 51 can pass is formed on one side of the partition 45. Fixing pieces 453 are secured on a top end of the partition 45 by using a means such as screws. When the upper cover 48 is fixed to the fixing pieces 453, the cover 48 can be coupled with the partition 45.

The partition 45 constructed as such can be manufactured by extrusion molding aluminum or aluminum alloy in a sectional shape as shown in FIG. 3(b), forming the passage aperture 452 and assembly screw holes, and securing the separately fabricated fixing pieces 453 on the top end of the partition. Alternatively, it may also be manufactured by forming a metal sheet.

Referring to FIGS. 1, 2 and 3, the front panel 46 is assembled at a front face of the main body 46, and is formed with exposure apertures 461, 462 for exposing a CD-ROM and a FDD at positions corresponding to the CD-ROM and the FDD to be installed in the first chamber 50. Referring to FIG. 3(d), the front panel 46 has stepped portions 463, 464 which are constructed such that the panel is bent rearward at upper and lower ends, the lower bent portion extending rearward is bent upwardly, and the upper bent portion extending rearward is bent downwardly. Then, the bent portions extending upwardly and downwardly are bent rearward again. The stepped portions 463, 464 are used to assemble the upper cover 48 and the base 43. Upper and lower edges of the front panel 46 are rounded.

The front panel 46 constructed as such is manufactured by extrusion molding aluminum or aluminum alloy in a sectional shape as shown in FIG. 3(d) and forming the exposure apertures 461, 462 and assembly screw holes.

Referring to FIGS. 1 and 2, the rear panel 47 is attached to a rear face of the main body 44. The rear panel 47 is formed with connection apertures 471, 472 which allow functional connectors of various card devices installed on the main board pursuant to standard requirements of the main board and functional connectors installed directly to the main board to be exposed to the exterior. A fixing bracket 473 is formed in the vicinity of the connection apertures 471 through which one end of each of various cards is exposed to the exterior for connecting with various connectors. The rear panel 47 may be manufactured by means of extrusion molding and post-processing, or by cutting and bending a metal sheet.

Referring to FIGS. 1 and 2, the upper cover 48 is attached to upper ends of the left and right supports 41, 42, the front panel 46 and the partition 45. It is manufactured by extrusion molding aluminum and aluminum alloy into a plate and forming assembly screw holes. Alternatively, it may be made of a typical metal sheet.

Referring to FIGS. 1, 2 and 3, the mounting structure 49 is placed in the first chamber 50 and fixed to the rails 431. The mounting structure 49 includes a horizontal plate 494 for separating a space into upper and lower space portions, and four side plates 495, 496, 497, 498 so as to form a first space portion 491 at an upper portion of the mounting structure for accommodating an optical disk drive and second and third space portions 492, 493 juxtaposed at a lower portion of the mounting structure for accommodating a FDD and a HDD. Horizontal fixing braces 498a, 497a are formed at lower ends of the lower left and middle side plates 498, 497 to be fixed to the rails 431. A horizontal fixing brace 495a is also formed at an upper end of the right side plate 495 to be fixed to the stepped portion 421 of the right support 42.

The mounting structure 49 is manufactured by extrusion molding aluminum or aluminum alloy in a sectional shape as shown in FIG. 3(c) and forming assembly screw holes.

Referring to FIGS. 1 and 2, the computer case 40 includes first to fourth closures 52, 53, 54, 55 to be fitted into both ends of each of the air-circulating passages 412, 422 of the left and right supports 41, 42.

The first closure 52 is fitted into a front end of the air-circulating passage 412 of the left support 41 and is formed in a solid type to prevent air from being introduced into the air-circulating passage. The second closure 53 is fitted into a rear end of the air-circulating passage 412 of the left support 41 and has an air-inflow aperture 531 formed therein. The third closure 54 is fitted into a rear end of the air-circulating passage 422 of the right support 42 and is formed with an air-outflow aperture 541 for discharging air within the second chamber 51 to the outside. The fourth closure 55 is fitted into a front end of the air-circulating passage 422 of the right support 42 to close the front end. The first to fourth closure 52, 53, 54, 55 are manufactured by injection molding plastic resin. The closures cover edge portions between the front panel, the left and right supports, and the rear panel. The edges of the closures are also rounded so that the edges of the computer case are rounded.

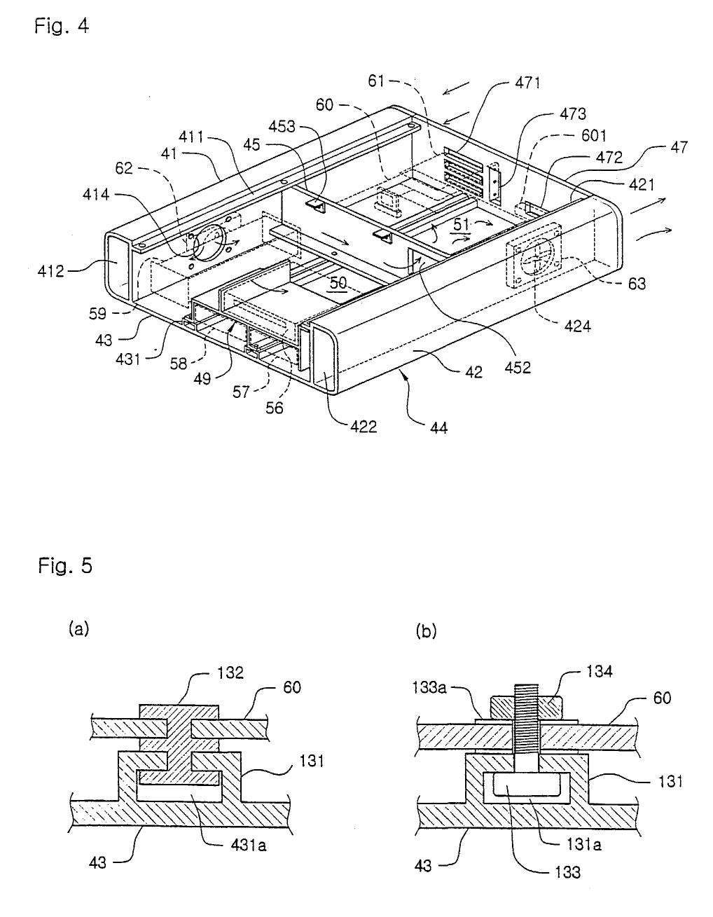

The computer case 40 constructed as such is assembled, as shown in FIGS. 1 and 4, by placing the front panel 46 on the front face of the main body 44, fixing the lower stepped portion 464 to the fixing rails 431 of the base by means of fasteners such as screws, and securing the upper stepped portion 463 of the front panel 46 on the stepped portions 411, 421 of the left and right supports 41, 42 by means of screws, etc. The rear panel 47 is placed on the rear face of the main body 44 and assembled to the left and right supports 41, 42 by fastening them using screws, etc.

The partition 45 and the mounting structure 49 are placed on the rails 431 of the base 43, and assembled by securing the fixing braces 451, 497a, 498a onto the fixing rails 431 by means of screws, etc. The upper cover 48 is positioned on a top face of the main body 44 and assembled to the stepped portions 411, 421, 463 of the left and right supports 41, 42 and the front panel 46 by fastening them using screws, etc.

The first and second closures 52, 53 are then fitted into both ends of the air-circulating passage 412 of the left support 41. The third and fourth closures 54, 55 are fitted into both ends of the air-circulating passage 412 of the right support 42.

FIG. 4 shows a state where various kinds of hardware devices are installed in the main body 44. As shown in the figure, an optical disk drive 56, a FDD 57, a HDD 58, and a power supply 59 are installed in the first chamber 50. The optical disk drive 56 is placed in the first space portion 491 of the mounting structure 49 and then fixed to the mounting structure 49 by fastening them using fasteners such as screws. The FDD 57 and the HDD 58 are positioned in the second and third space portions 492, 493, respectively, and then fixed to the mounting structure 49 by securing them using fasteners such as screws.

The main board 60 and various circuit card devices 61 are installed in the second chamber 51. The main board 60 is placed on the rails 43 and can be fixed thereto, for example, by using a fastener 132 as shown in FIG. 5(a). The fastener 132 fixed to the main board 60 has a head 132a extending via a neck. The head 132a is fitted into a space 431a of the rail 431. Alternatively, as shown in FIG. 5(b), the main board may be secured by using a bolt 133 and a nut 134. Referring to FIG. 5, the bolt 133 is assembled in the fixing space 431a of the rail. The head of the bolt 133 can be inserted into the space 431a by inserting it at one end of the rail and pushing and moving it therein. A washer 133 made of insulating materials is then fitted over the bolt 133, the main board 60 is placed on the washer by fitting it over the bolt, another washer 133 is fitted over the bolt, and the nut 134 is screwed.

Various kinds of circuit card devices 61 can be installed by inserting them into slots of riser cards stood on the main board 60, exposing parts to be connected through the connection apertures 471 formed in the rear panel 47, and securing them to the fixing bracket 473 using screws. In addition through the other connection aperture 472 of the rear panel 47, functional connection parts, such as ports for a keyboard, a mouse and a printer and a power receptacle, provided to the main board can be exposed.

Furthermore, blowing fans 62, 63 are installed in the communicating aperture 414 for communicating the first chamber 50 with the air-circulating passage 412 of the left support 41 and the communicating aperture 424 for communicating the second chamber 51 with the air-circulating passage 422 of the right support 42, respectively. The blowing fan 62 on the side of the first chamber 50 causes air to flow from the air-circulating passage 412 to the first chamber 50, whereas the blowing fan 63 on the side of the second chamber 51 causes air to flow from the second chamber 51 to the air-circulating passage 422. Thus, the air is forcibly circulated alone a flow path to prevent various hardware devices installed in the first and second chambers 50, 51 from overheating.

With such constitutions, the air flows via the second closure 53—the air-circulating passage 412 of the left support 41—the first chamber 50—the passage aperture 452 of the partition 45—the second chamber 51—the air-circulating passage 422 of the right support 42—and finally the third closure 54, as shown in FIG. 4. However, the present invention is not limited thereto. To the contrary, the air may also circulate in reverse order. That is, the air may circulate via the third closure 54—the air-circulating passage 422 of the right support 42—the second chamber 51—the passage aperture 452 of the partition 45—the first chamber 50—the air-circulating passage 412 of the left support 41—and then the second closure 53. In this case, air introduced from the outside first passes through a space containing a CPU of the second chamber.

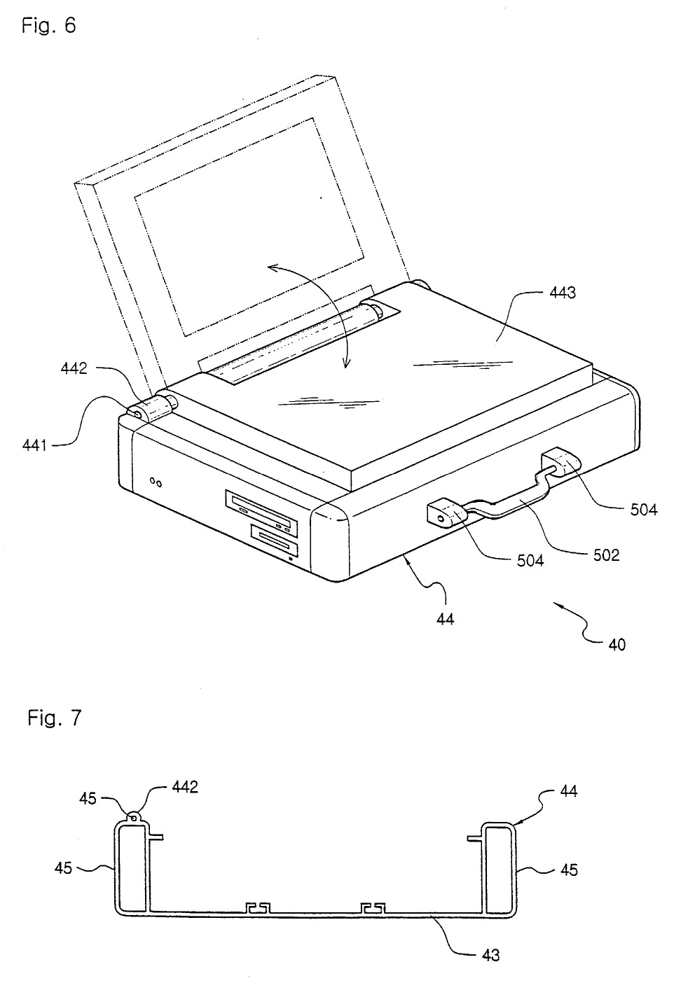

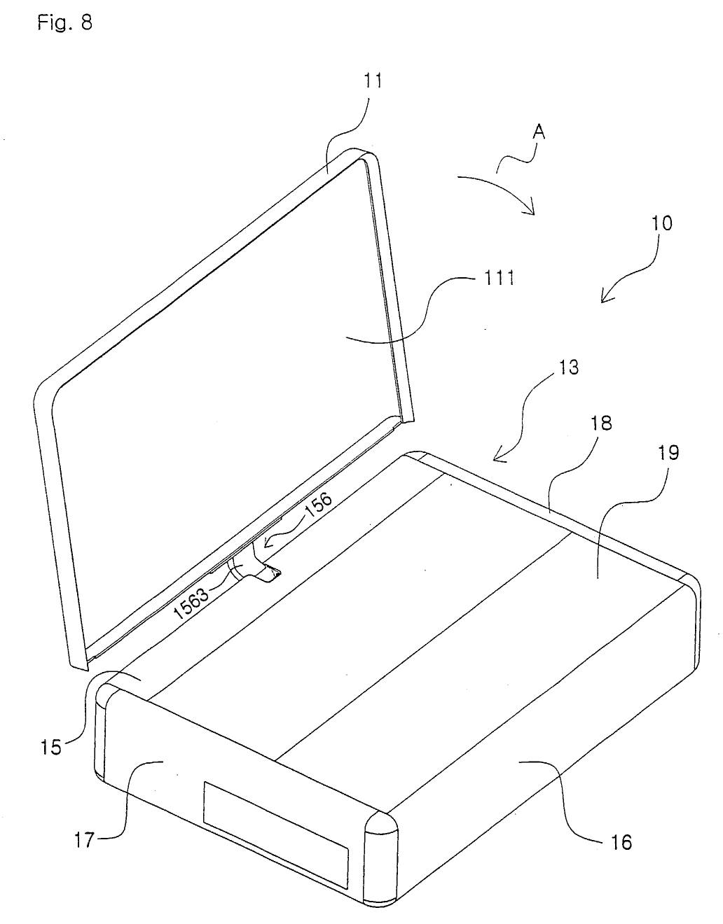

FIG. 6 shows a modified embodiment of the first embodiment. A flat panel display device 443 such as a LCD is coupled via hinge portions 442 with a computer case of the modified embodiment. Therefore, its mobility can be enhanced. To achieve this, the main body 44 includes the hinge portions 442 with hinge apertures 441 at the upper portion of the left support 41, as shown in FIG. 7. Hinge shafts of the display device 443 are fitted into the hinge apertures 441 in order to rotate. Referring to FIG. 6 again, the main body 44 is provided with a handle 502. The handle 502 is hinged to handle-supporting brace 504 provided on one side of the main body 44.

Second Embodiment

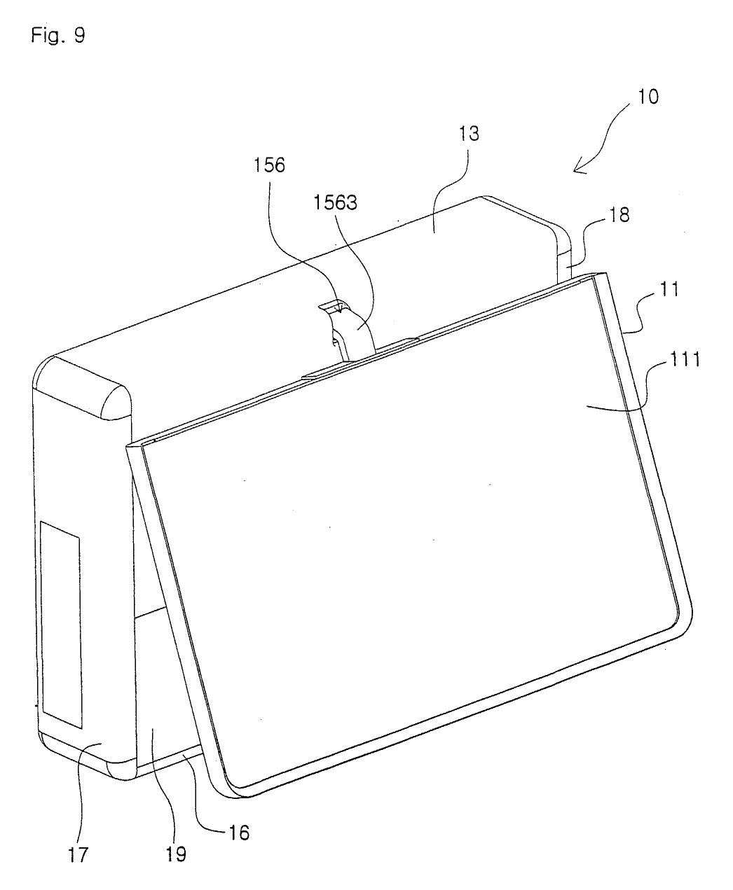

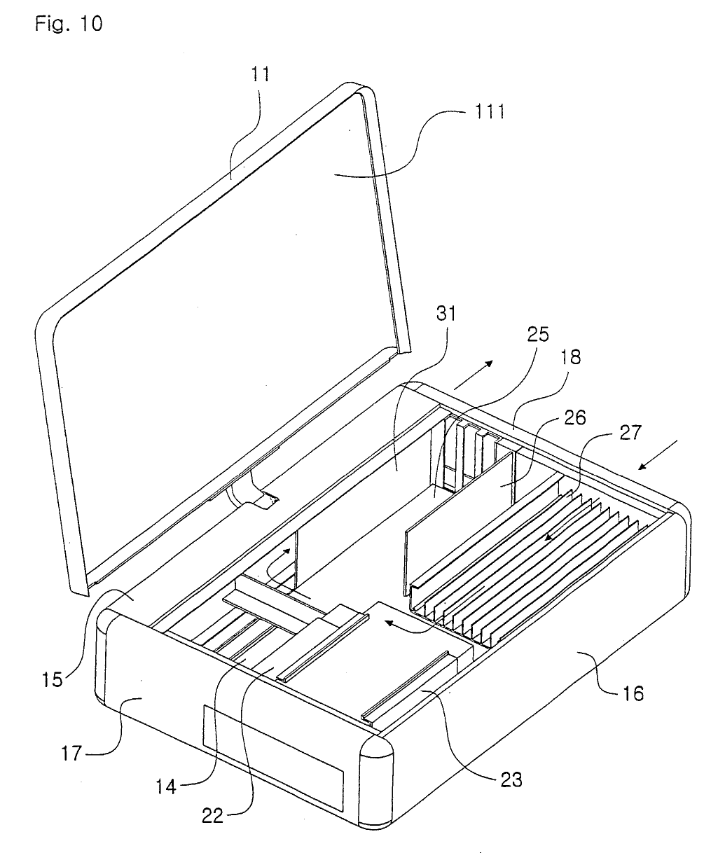

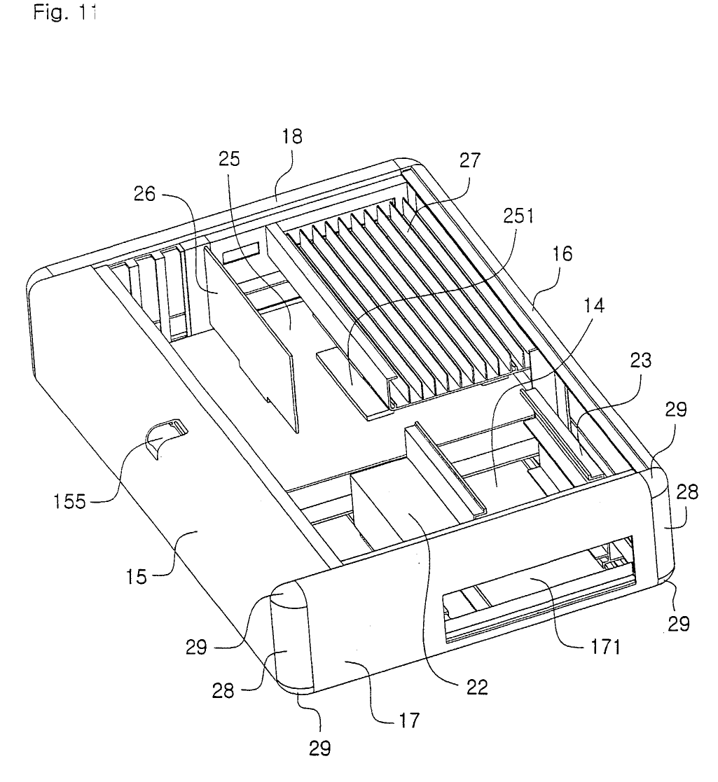

Referring to FIGS. 8 and 9, the computer 10 includes a display device 11 integrally coupled therewith. To this end, the computer 10 includes a computer case 13 according to a second embodiment of the present invention. Referring to FIG. 8, the display device 11 can be rotated in a direction designated by an arrow A about a hinge device contained in the computer case 13. In addition, in a case where the computer is used in a state stood vertically as shown in FIG. 9, the display device 11 is rotated (revolved) over 180 degrees about a neck to expose a screen 111 of the display device 11. The orientation of the screen of the display device shown in FIG. 9 is made by turning up the screen of the display device shown in FIG. 8. For this change in orientation, it is necessary for a user to easily change a configuration by modifying a graphic board device or software installed in the computer. It will be apparent to a person having an ordinary skill in the art that the modification to the graphic card device or software can be easily made.

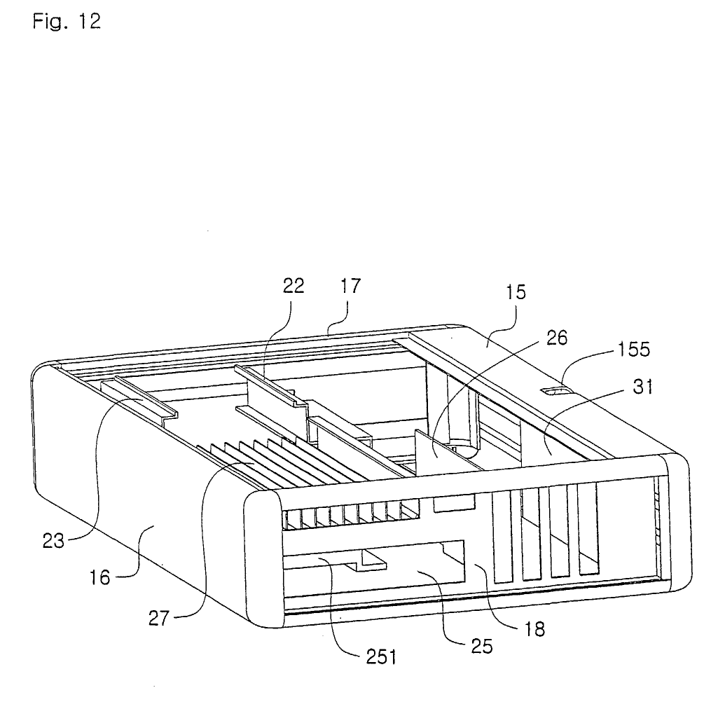

Referring to FIGS. 8 to 12, the computer case 13 includes a bottom base 14, a left support 15, a right support 16, a front panel 17, a rear panel 18 and an upper cover 19. In FIGS. 10 to 12, the upper cover 19 and some bars for forming a supporting frame to be described later are omitted so that devices mounted in the interior of the computer case can be well seen in the figures. Mounting structures 22, 23 for fixing storage devices such as a CD-ROM, a HDD and a FDD are installed in a forward portion of the interior, and a main board 25 is installed in a rearward portion thereof. A circuit card device 26 used for performing a specific function is mounted on the main board 25. An airflow-guiding member 27 is installed above a CPU of the main board 25.

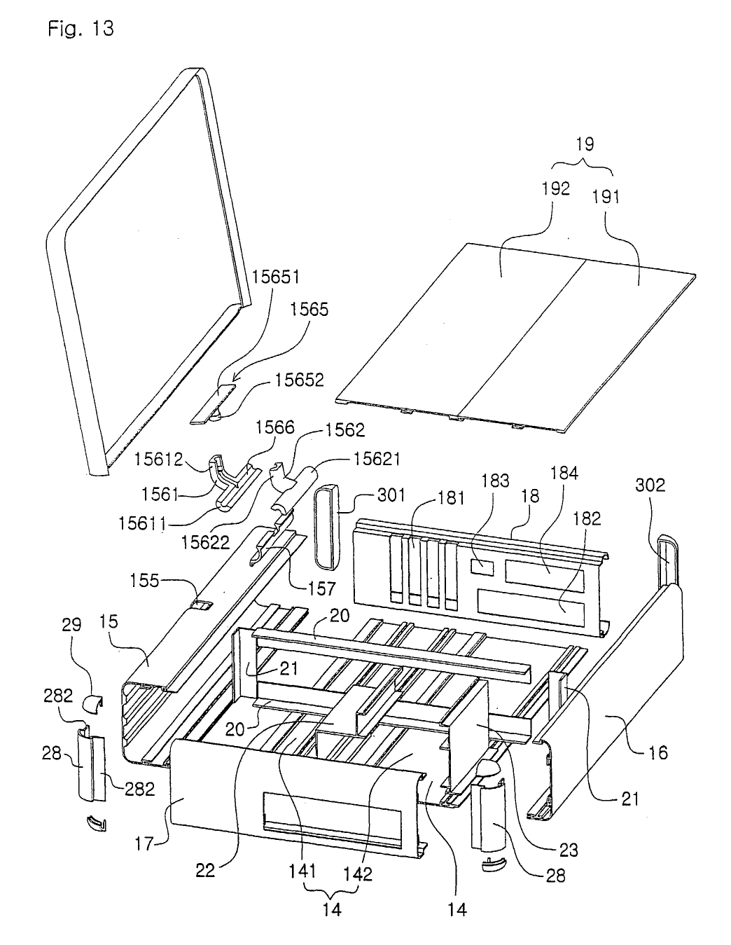

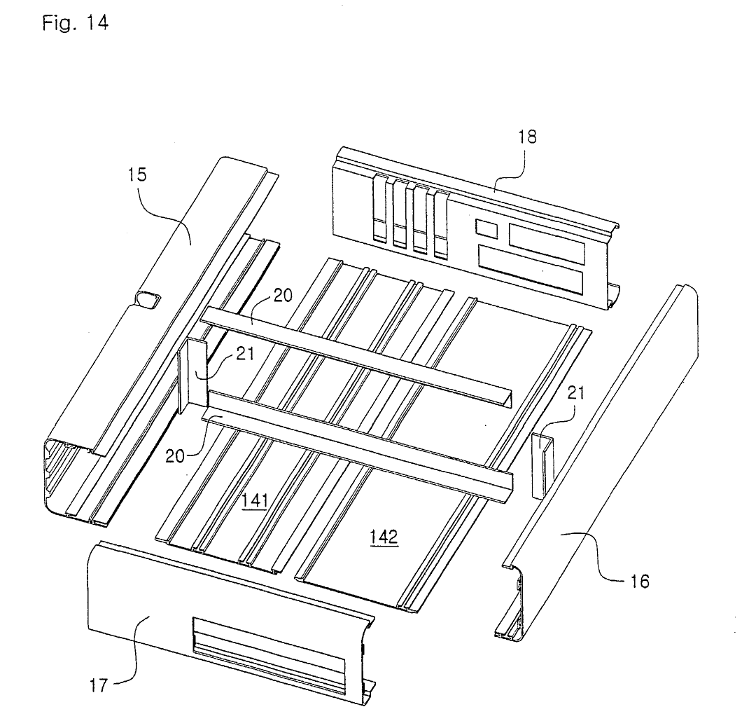

The bottom base 14 will be described with reference to FIGS. 13, 14, 16 and 17(a) and (b). The base 14 consists of a first base member 141 and a second base member 142. The first base member 141 has a uniform shape in a section taken in a direction perpendicular to the lengthwise direction. Two rails 1412 are provided on a flat plate 1411 of the first base member. A coupling projection 1413 for coupling with the left support 15 is provided on a left end of the flat plate, and a coupling groove 1414 for coupling with the second base member 142 is provided on a right end of the flat plate.

The second base member 142 is provided with one rail 1422 toward the right of a flat plate 1421. A coupling projection 1423 for coupling with the first base member 141 is provided on a left end of the flat plate, and a coupling projection 1424 for coupling with the right support 16 is provided on a right end of the flat plate.

The first and second base members 141, 142 constituting the base 14 are made by extrusion molding aluminum or aluminum alloy and are then finished by means of post-processing such as formation of screw holes. When the coupling projection 1423 at the left end of the second base member is fitted into the coupling groove 1414 of the right end of the first base member, the base 14 is finally constructed.

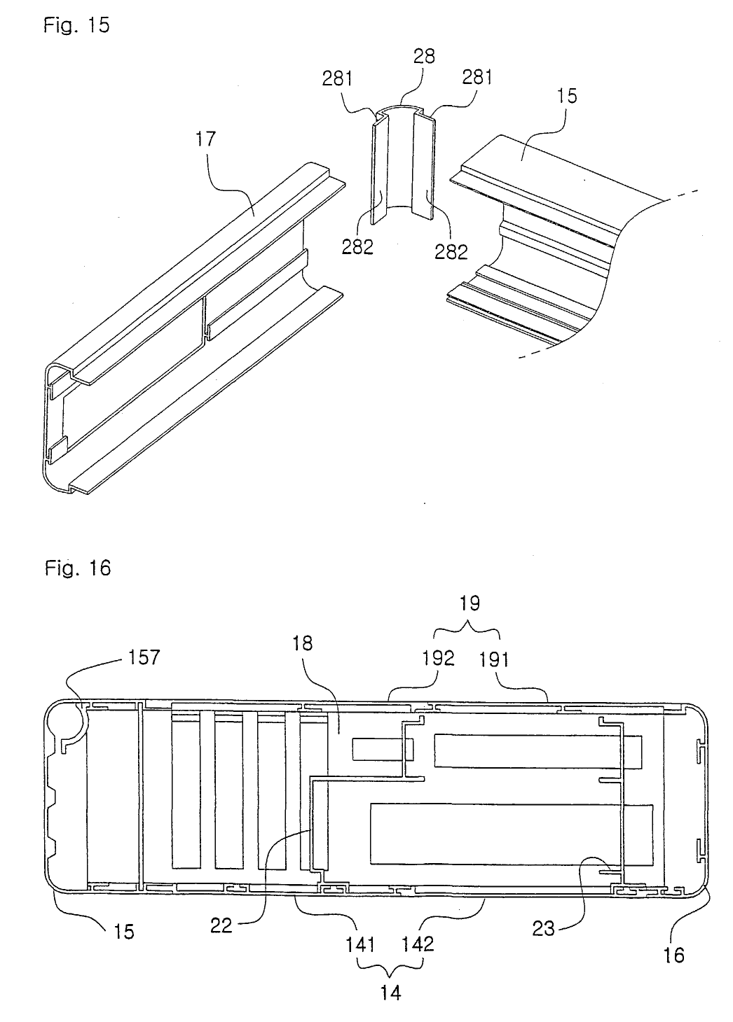

The left support 15 will be described with reference to FIGS. 8 to 16 and 17(f). The left support 15 has a uniform shape in a section taken in a direction perpendicular to the lengthwise direction. The left support 15 includes a vertical plate 151, an upper wing 152 extending from an upper end of the vertical plate 151 rightward, and a lower wing 153 extending from a lower end of the vertical plate rightward. Mounting projections 154 are provided on an inner surface of the vertical plate 151 so as to protrude inward. A heat-dissipating part in a power supply contained within the computer can be mounted directly on the projections. The edges of the projections are rounded.

A screw fixing structure 1521, which is constructed such that it protrudes downwardly and is bent to extend in parallel with the upper wing, is provided on the bottom of the upper wing 152. A coupling groove 1522 for the power supply is provided at an end portion of the upper wing. A stepped projection 1523 for forming a step is provided at a distal end of the upper wing so that the upper cover 19, to be described later, can be seated thereon.

A screw fixing structure 1531, which is constructed such that it protrudes upwardly and is bent to extend in parallel with the lower wing, is provided on the top of the lower wing 153. A coupling groove 1532 for the power supply is provided at an end portion of the lower wing. A coupling groove 1534 into which the left coupling projection 1413 of the first base member 141 is fitted is formed at a distal end of the lower wing.

A circuit board 31 for the power supply is fitted into the coupling grooves 1522, 1532 for the power supply. Parts for supplying electric power are mounted on the circuit board 31 for the power supply. As described above, some heat-dissipating parts are attached directly to the left support 15 to facilitate rapid cooling. The power supply used for the second embodiment of the present invention is a type having only a board secured on a device without requiring a separate housing, contrary to a typical power supply. With such constitution, the circuit board 31 can naturally form an airflow duct in the left support.

An aperture 155 is formed at a middle portion of the left support 15. A hinge device 156 extends through the aperture 155 to rotatably support the display device. The left support 15 is finished by extrusion molding aluminum or aluminum alloy, cutting it at a proper length, and forming the aperture 155 for the hinge device therein by means of post-processing.

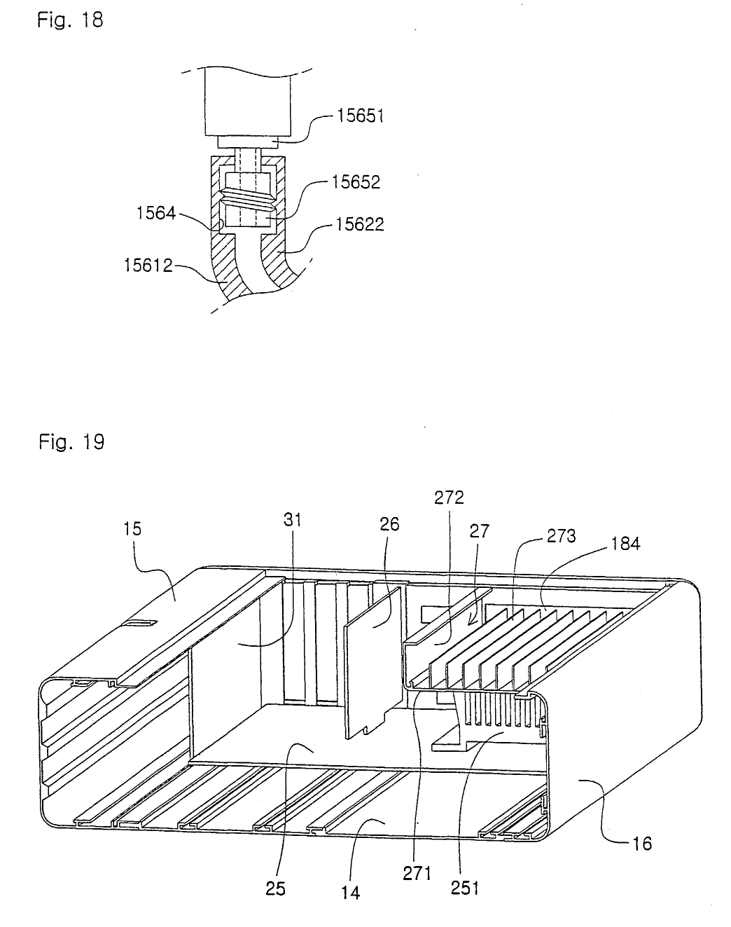

Referring to FIG. 13, the hinge device 156 includes a first hinge member 1561 and a second hinge member 1562. The first and second hinge members 1561, 1562 include hinge shaft-forming portions 15611, 15612, respectively. These hinge shaft-forming portions 15611, 15621 form a cylindrical hinge shaft when assembled together. The respective hinge members 1561 are provided with neck-forming portions 15612, 15622 which extend from the hinge shaft-forming portions 15611, 15621 and are bent at a right angle. A neck 1563 is formed when the neck-forming portions are coupled together. The neck protrudes outward through the aperture of the left support 15 (see FIGS. 8 and 9). Referring to FIGS. 13 and 18, a revolving hinge shaft-inserting space 1564 in the form of cylinder is provided in the neck 1563. On the other hand, the center portions of the hinge shaft and neck are provided with passages through which wires can pass. To this end, grooves 1566 are recessed into the hinge shaft-forming portions 15611, 15621 and the neck-forming portions 15612, 15622.

The hinge device 156 further includes a revolving hinge base 1565. The revolving hinge base 1565 includes a brace 15651, and a revolving hinge shaft 15652 connected to the brace and inserted into the inserting space 1564. The display device 11 is secured on the brace 15651. A wire passage is formed in the center of the revolving hinge base 1565. As shown in FIG. 18, axial movement of the revolving hinge shaft 15652 is limited by sill portions formed in the respective hinge members 1561, 1562.

A periphery of the revolving hinge shaft 15652 is provided with threads, and an inner surface of the inserting space 1564 is provided with relevant threads engaging with the threads of the revolving hinge shaft. Thus, when the display device is rotated, the revolving hinge shaft 15652 moves axially. However, since the axial movement is limited by the sill portions, and accordingly, the range of rotation of the revolving hinge shaft 15652 is limited, a twist in the wire passing through the wire passage can be prevented. It is preferable that the range of rotation of the revolving hinge shaft 15652 be from 180 to 360 degrees.

On the other hand, the hinge shaft formed by the hinge members 1561, 1562 is supported by a shaft-supporting member 157 shown in FIG. 13. The shaft-supporting member 157 is fixed to the left support 15 and provides a space into which the hinge shaft is inserted in order to rotate (see FIG. 16). As seen in FIG. 16, when assembled, a distal end of the shaft-supporting member 157 should be spaced at a distance from the vertical plate 151 of the left support 15. This is in order to assemble the shaft-supporting member 157 closer to the vertical plate 151 when the hinge shaft comes loose due to its wear. Although the respective members of the hinge device may be manufactured by injection molding plastic resin, the present invention is not limited thereto.

The right support 16 will be described with reference to FIGS. 8 to 14, 16 and 17(c). The right support 16 has a uniform shape in a section taken in a direction perpendicular to the lengthwise direction. The right support 16 includes a vertical plate 161, an upper wing 162 extending from an upper end of the vertical plate 161 leftward, and a lower wing 163 extending from a lower end of the vertical plate leftward. A stepped projection 1623 for forming a step is provided at a distal end of the upper wing 162 so that the upper cover 19, to be described later, can be seated thereon. A coupling groove 1634 into which the coupling projection 1424 in the right base member 142 of the bottom base is provided at a distal end of the lower wing 163. The right support 16 is provided with a screw fixing rib structure 165 having the same shape as the screw fixing rib structure provided on the left support 15. The right support 16 is finished by extrusion molding aluminum or aluminum alloy, cutting it at a proper length, and forming screw holes therein by means of post-processing.

Referring to FIGS. 8 to 15 and 17(g), the front panel 17, which is assembled at the front face of the case, is provided with an exposure aperture 171 for exposing a CD-ROM and a FDD at a position corresponding to the CD-ROM and FDD installed in the interior of the case. The front panel 17 is provided with stepped portions 173, 174 which are constructed such that the panel is bent rearward at upper and lower ends, the lower bent portion extending rearward is bent upwardly, and the upper bent portion extending rearward is bent downwardly. The bent portions extending upwardly and downwardly are bent rearward again. The stepped portions 173, 174 are used to assemble the upper cover 19 and the base 14. Upper and lower edges of the front panel 17 are rounded. The front panel 17 is provided with a screw fixing rib structure 175 having the same shape as the screw fixing rib structure provided on the left support 15.

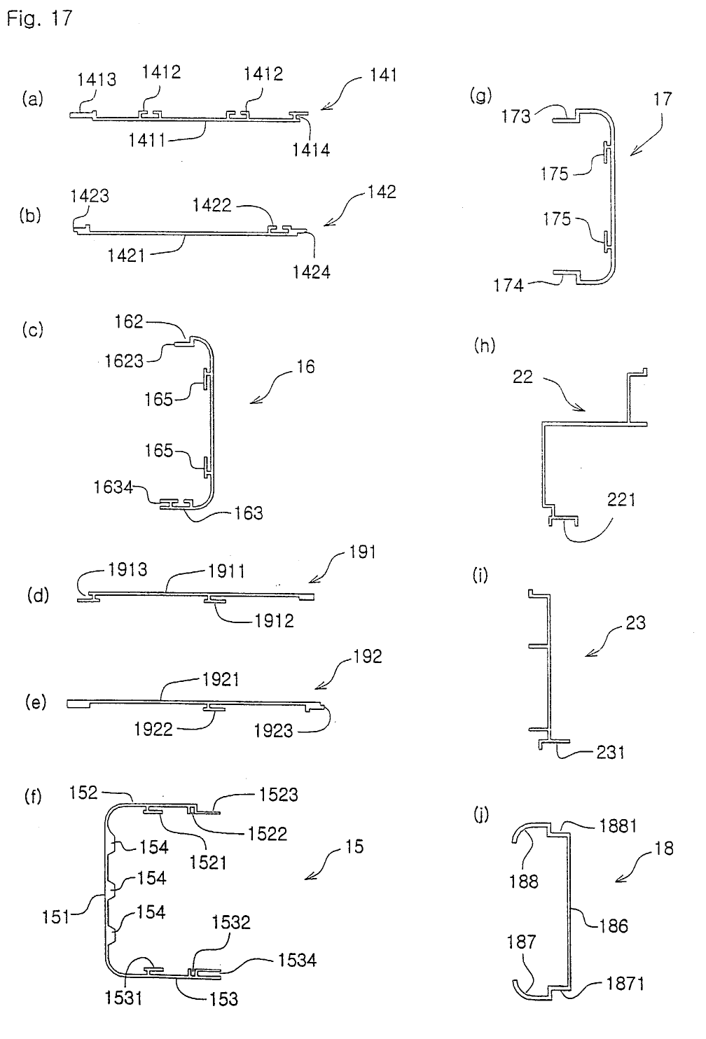

The front panel 17 constructed as such is manufactured by extrusion molding aluminum or aluminum alloy in a sectional shape as shown in FIG. 17(g) and forming the exposure aperture 171 and assembly screw holes by means of post-processing.

Referring to FIGS. 8 to 14, 16 and 17(j), the rear panel 18, which is assembled at the rear face of the case, is provided with connection apertures 181 through which functional connectors of various card devices installed on the main board pursuant to the standard requirements of the main board can be exposed to the exterior. The rear panel also has a connection aperture 182 to allow functional connectors installed directly on the main board to be exposed to the exterior. Furthermore, an E-IDE connection aperture 183 and an air-suction opening 184 are also provided therein. An airflow-guiding device 27 is fixed in the vicinity of the air-suction opening 184.

The rear panel 18 is manufactured by forming various apertures, and assembly screw holes therein by means of post-processing after extrusion molding. As shown in FIG. 17(j), the rear panel 18 includes wings 187, 188 extending rearward from a plate 186 having the apertures formed therein, and is provided with stepped portions 1871, 1881 at edges between the wings and the plate. The base 14 and cover 19 are superposed and fixed on the stepped portion 1871, 1881. Distal ends of the respective wings 187, 188 are curled roundly and inwardly.

As shown in FIGS. 11, 13 and 15, a front connecting member 28 is interposed between the front panel 17 and the side supports. The edges of the connecting member 28 are rounded. Both ends of the connecting member are provided with a pair of wings 282, which form an angle of 90 degrees together, abutted on inner portions of the front panel 17 and the left support (or right support) and fixed thereto by using screws, etc. Each of the wines 282 is somewhat depressed inwardly to form a stepped portion 281. The connecting portion 28 is finished by extrusion molding a metal material and forming screw holes by means of post-processing. Corner portions between the front panel 17 and the left and right supports 15, 16 are provided with corner members 29 for rounding the corner portions. On the other hand, connecting members 301, 302 are also provided even between the rear panel 18 and the left and right supports 15, 16, as shown in FIG. 13. The connecting members are used for roundly finishing portions between the rear panel 18 and the left and right side supports 15, 16, and preferably manufactured by injection molding plastic resin. It is preferable to provide the left connecting member 301 of the FIG. 13 with an air-outflow opening in the form of grill.

Referring to FIGS. 8, 13, 16 and 17(d) and (e), the upper cover 19 consists of a first cover member 191 and a second cover member 192. The first cover member 191 has a uniform shape in a section taken in a direction perpendicular to the lengthwise direction. A screw fixing rib structure 1912 is provided at the bottom of a flat plate 1911 of the first cover member. A left end of the plate is provided with a coupling groove 1913 for coupling with the second cover member 192, and a right end thereof is placed on the stepped portion 173 of the right support (see FIG. 16).

A screw fixing rib structure 1922 is located at the bottom of a flat plate 1921 of the second cover member 192. A left end of the plate is placed on the stepped portion 1523 of the left support (see FIG. 16). A right end thereof is provided with a coupling projection 1923 for coupling with the first cover member 191.

The first and second members 191, 192 constituting the cover 19 are manufactured by extrusion molding aluminum or aluminum alloy and forming screw holes by means of post-processing. When the coupling projection 1923 at the right end of the second cover member is fitted into the coupling groove 1913 of the left end of the first cover member, the cover 19 is finally constructed. The cover 19 is finally assembled after required devices have been mounted in the computer case 10. At this time, the cover is assembled thereto so as to be easily detachable.

Referring to FIGS. 10 to 13, 16, and 17(h) and (i), the mounting structure consists of two mounting structures 22, 23, contrary to the first embodiment. These mounting structures 22, 23 are extrusion molded to have uniform shapes in sections taken in a direction perpendicular to the lengthwise direction.

The mounting structures 22, 23 include feet 221, 231 placed on and fixed to the rails 1412, 1422. The mounting structures 22, 23 face each other and form a space portion for accommodating an optical disk drive in the lower portions and a space portion for accommodating a FDD in the upper portions. These mounting structures 22, 23 are not limited to those shown in FIG. 16, but may employ the mounting structure of the first embodiment or other mounting structure. However, it can be understood by a person having an ordinary skill in the art that the exposure apertures provided in the front panel 17 can be formed in accordance with the mounting structure used.

Referring to FIGS. 13 and 14, it is preferable to provide the interior of the computer case 13 with a supporting frame by coupling crossbars 20 and vertical bars 21 at the center in the fore-and-aft direction. The lower crossbar 20 is fixed to the bottom base 14. The vertical bars 21 are fixed to the left and right supports 15, 16, respectively. The base 14 and the left and right support 15, 16 are securely coupled by means of the frame. The supporting frame partitions the interior of the computer. Generally, storage devices are disposed in the front of the supporting frame and circuit devices such as a main board are placed in the rear of the frame.

Referring to FIGS. 10 to 12 and 19, the airflow-guiding member 27 is installed on a cooling structure 251 of the CPU mounted on the main board 25. The airflow-guiding member 27 forms a passage through which air introduced through the air-suction opening 184 passes, so that the sucked cool air first cools the CPU. The airflow-guiding member 27 has a uniform shape in a section taken in a direction perpendicular to the lengthwise direction. The airflow-guiding member 27 includes a bottom plate 271, both side walls 272, and a plurality of fins 273 protruding from the bottom plate and arranged in parallel so as to transfer heat radiated from the cooling structure of the CPU to the passing air. A filter (not shown) is installed at the air-suction opening 184. In addition, if the side walls of the airflow-guiding member 27 are in direct contact with the upper cover 19, heat is transferred to the atmosphere via the metal so that the cooling efficiency for the CPU is further enhanced.

With such constitution, as designated by arrows in FIG. 10, the airflow is introduced toward the airflow-guiding member 27 to first cool the CPU, passes through the interior of the computer, and is discharged to the outside via a duct formed by the circuit board 31 for the power supply. To this end, it is necessary to provide a blowing fan at an appropriate position in the computer.

Compared with the first embodiment, it can be understood that the computer case of the second embodiment is comprised of various small parts. This is to reduce the production costs of a die for extrusion molding.

In the above description of the second embodiment, it has been explained that the hinge device is completed under condition that the display device has been coupled with the brace 15651. On the contrary, they may be constructed such that they are separately manufactured and then can be coupled or disassembled by a user in their use as occasion demands.

Third Embodiment

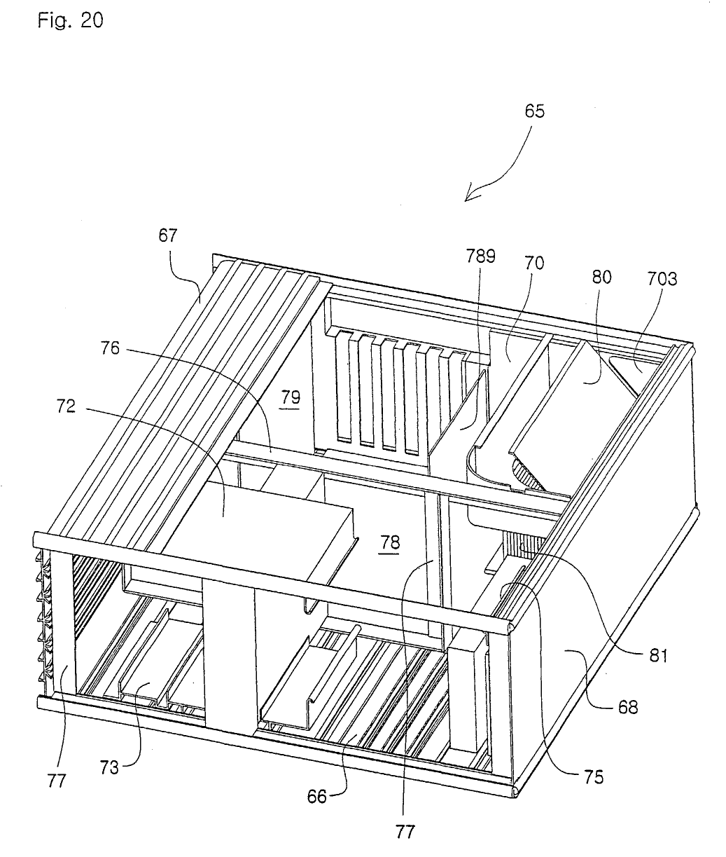

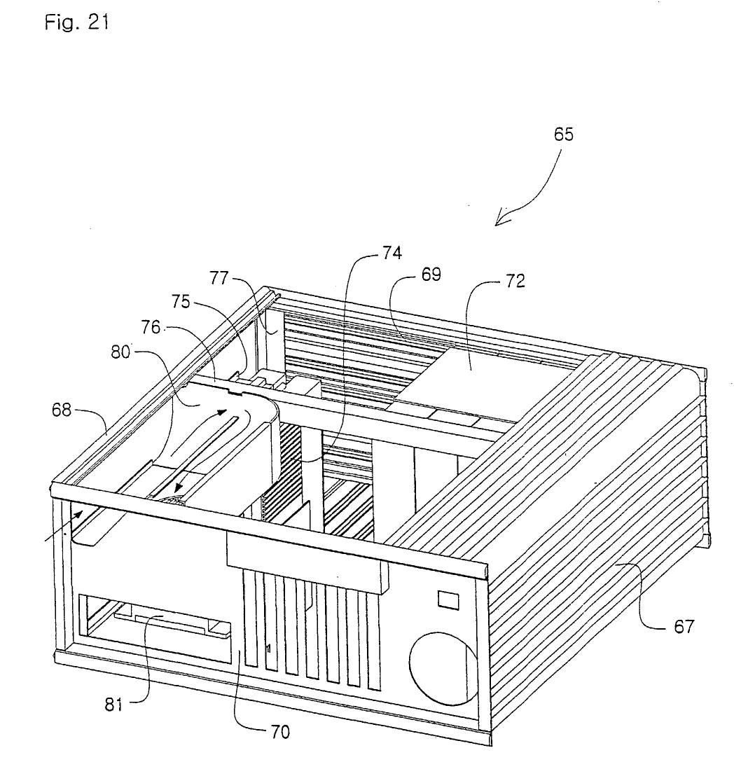

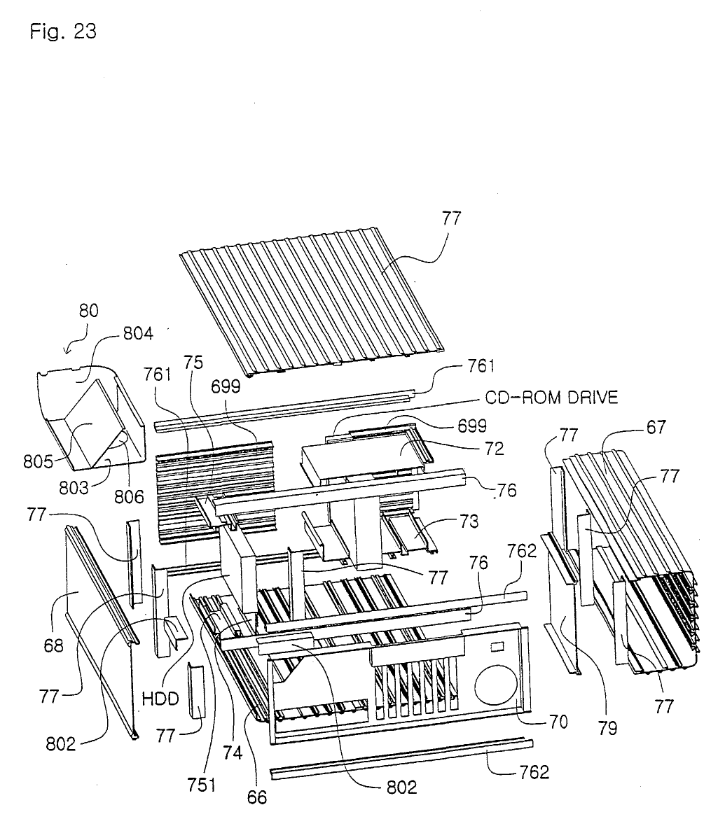

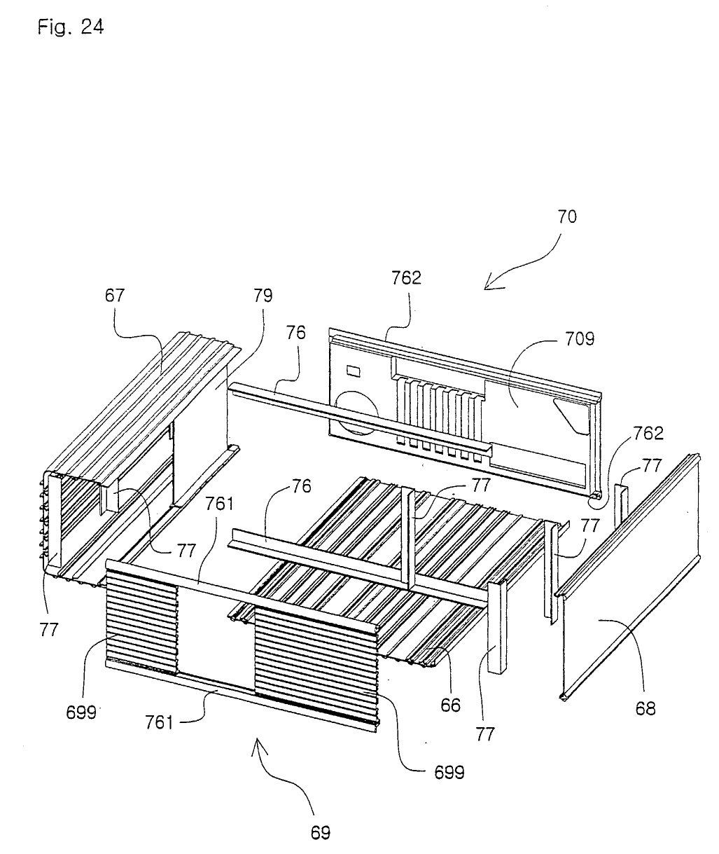

Although a computer case of the third embodiment has a height larger than its width to be used vertically, it will be explained henceforth in a state laid on its the side. Referring to FIGS. 20 to 24, a computer case 65 includes a bottom base 66, a left support 67, a right support 68, a front panel 69, a rear panel 70, and an upper cover 71. Referring to FIGS. 20 and 21, mounting structures 72, 73, 74, 75, 751 for fixing storage devices such as a CD-ROM, a HDD and a FDD are installed in the front interior of the case, and a main board 78 is installed in the rear interior thereof. A circuit card device 789 for performing a specific function is mounted on the main board 78. An airflow-guiding member 80 is installed above a CPU of the main board 78.

The bottom base 66 will be explained with reference to FIGS. 20, 22 to 25 and 26(a) and (b). The base 66 consists of a first base member 661 and a second base member 662. The first base member 661 has a uniform shape in a section taken in a direction perpendicular to the lengthwise direction. Two rails 6611 are provided on a flat plate 6619 of the first base member. A left end of the plate is provided with a coupling projection 6614 for coupling with the left support 67. A right end of the plate is placed on a stepped portion 6624 of the second base member 662 and fixed thereto using screws, etc. The rails 6611 are the same shape as the rails of the first embodiment.

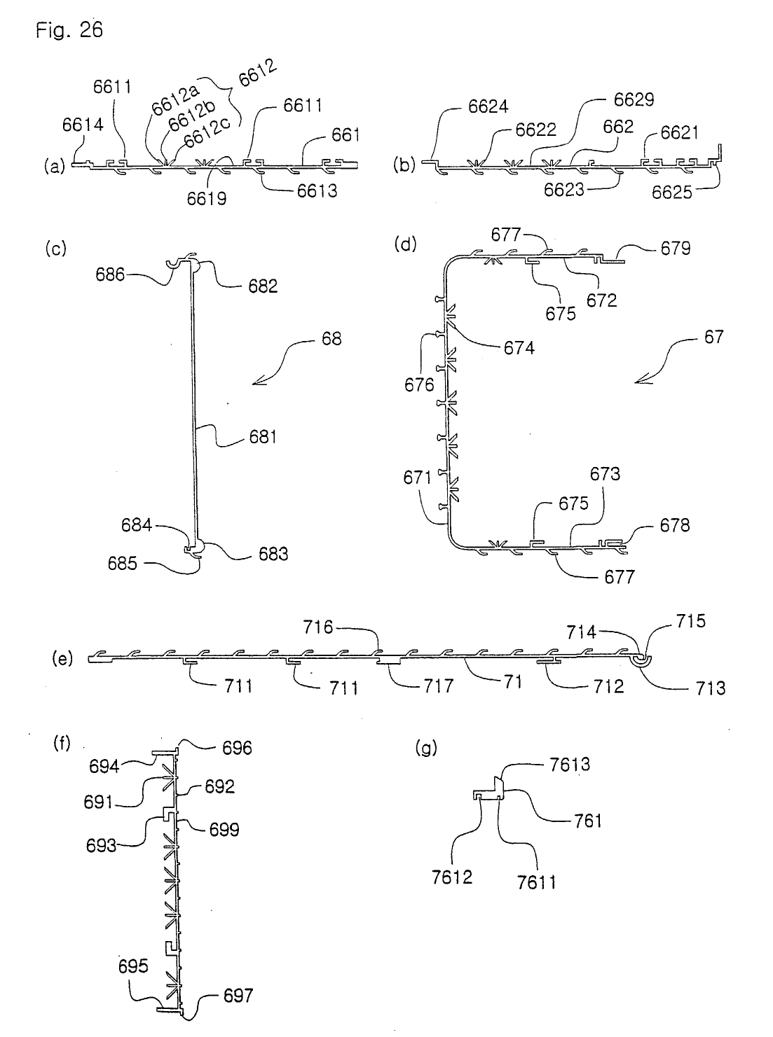

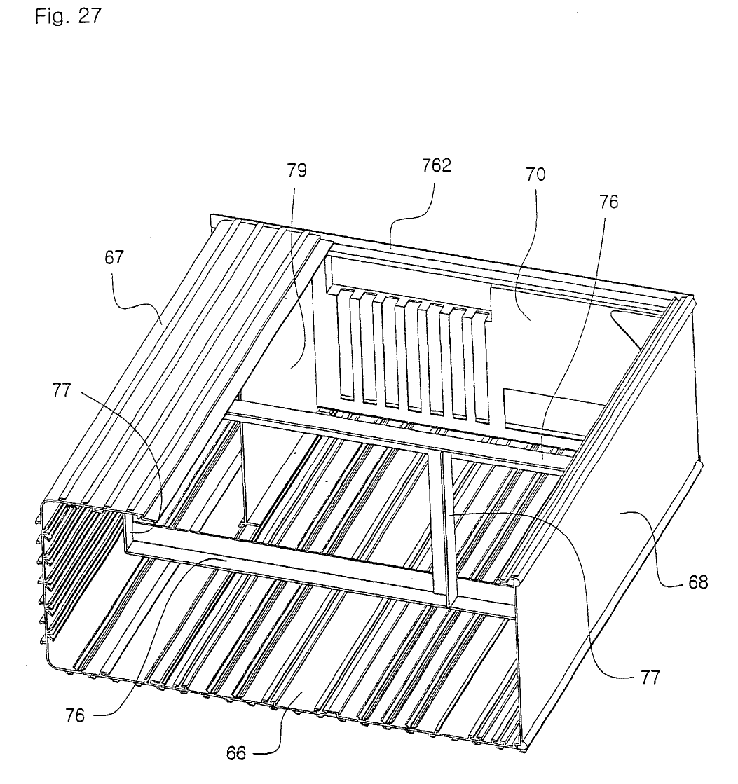

A noise-reducing rib structure 6612 for reducing noise is provided on the plate. It is configure to have a plurality of ribs radially protruding from a point on the plate. That is, as for the plate of FIG. 26(a), the ribs 6612a, 6612b, 6612c protrude therefrom at angles of 45, 90 and 135 degrees, respectively. Vibration of air is transferred to the first base member 661 while being attenuated between ribs or the ribs and the plate, so that noise is not easily transferred to the outside of the computer case constructed by the base member 661.

Heat-dissipating fins 6613 are provided on an outer surface of the first base member 661. It is preferable that the fins 6613 be slanted so that their tips are directed downwardly when the computer case 65 is stood vertically with the right support positioned at the bottom.

The second base member 662 shown in FIG. 26(b) has a rail 6621 positioned toward the right of a flat plate 6629. A left end of the plate is provided with a stepped portion 6624 onto which the first base member 661 can be seated. A coupling projection 6625 to be inserted into a groove 684 of the right support 68 is provided in the vicinity of a right end of the plate. The right end further extends vertically, as seen in the figure. A top surface of the second base member 662 is provided with a plurality of noise-reducing rib structures 6622 positioned parallel to each other. All the noise-reducing rib structures provided in the computer case of this embodiment have the same identical constitution as the noise-reducing rib structure on the first base member 661. A bottom surface of the second base member is provided with a plurality of fins 6623 having the same constitution as the fins on the first base member.

The first and second base members 661, 662 constituting the base 66 are finished by extrusion molding aluminum or aluminum alloy and forming screw holes by means of post-processing after the extrusion molding. The base 14 is finally constructed by putting the right end of the first base member and the left end of the second base member together, and coupling them with a fastening member.

The left support 67 will be described with reference to FIGS. 20 to 25 and 26(d). The left support 67 has a uniform shape in a section taken in a direction perpendicular to the lengthwise direction. The left support 67 includes a vertical plate 671, an upper wing 672 extending from an upper end of the plate 671 rightward, and a lower wing 673 extending from a lower end of the plate rightward. A noise-reducing rib structure 674 is provided on an inner surface of the vertical plate 671. A plurality of heat-dissipating fins 676 are provided on an outer surface of the vertical plate 671.

The bottom of the upper wing 672 is provided with a fixing rib structure 675 and a noise-reducing rib structure which protrude therefrom and which are bent and then extended. A stepped portion 679 is provided at end portions of the upper wing. A top surface of the lower wing 673 is provided with a fixing rib structure 675 and a noise-reducing rib structure. A distal end of the lower wing is formed with a coupling groove 678 into which the left coupling projection 6614 of the first base member 671 is inserted. The fixing rib structures of the upper and lower wings provide the coupling with the mounting structures 71, 73. On the other hand, a partition 79 is provided in the rear of the left support 67, and a power supply P is mounted in the partitioned space.

The right support 68 will be described with reference to FIGS. 20 to 25 and 26(d). The right support 68 has a uniform shape in a section taken in a direction perpendicular to the lengthwise direction. The right support 68 includes a vertical plate 681, an upper hoof 682 at an upper end of the vertical plate 681, and a lower hoof 683 at a lower end of the plate. When the computer is stood vertically with the right support 68 positioned at the bottom thereof, the hooves 682, 683 are placed on the floor.

A rotation supporting projection 686 curled in the shape of an arc is placed opposite to the hoof at the upper end of the right support 68. This projection allows an upper cover 71, which will be described later, to rotate. A coupling groove 684 into which the right coupling projection 6625 of the second base member 662 is fitted is placed opposite the hoof of the lower end. The right support 68 is manufactured by extrusion molding aluminum or aluminum alloy, cutting it at a proper length, and post-processing screw holes, etc.

Referring to FIGS. 21 to 24 and 26(f) and (g), the front panel 17 is assembled at a front face of the case, and includes two front face members 699 spaced with a predetermined gap therebetween, and connecting bars 761 coupled with upper and lower ends of the front face members. The space between the two front face members 699 and the connecting bars 761 defines an exposure aperture for exposing a CD-ROM and a FDD at positions corresponding to the CD-ROM and the FDD to be installed in the interior of the case.

The left and right front face members 699 are formed by properly cutting an elongated member with a uniform shape in the section. An inner surface of the front face members 699 is provided with a noise-reducing rib structure 691 and a screw fixing rib structure 693. An outer surface of the front face members is provided with protruding fins 692 for dissipating heat. The upper and lower ends of the front face member are provided with wings 694, 695 which are formed with screw holes (not shown) for coupling the connecting bars with the wings. Coupling projections 696, 697, which protrude perpendicularly to the wings 694, 695, are placed in the front portions of the wings 694.

The length of the connecting bar 761 becomes the length of the front panel 69. The sectional shape of the connecting bar 761 is uniform. As shown in FIG. 26(g), the coupling projections 696, 697 of the front face member 699 are fitted into coupling grooves 7611 provided in the connecting bar. Threaded grooves 7612 are provided at positions spaced apart from the coupling grooves 7611. Thread portions of screws introduced from the wings of the front face member 699 are fitted into and fastened to the threaded grooves. Thus, the front face members 699 and the connecting bars 761 are coupled together. The connecting bars 761 have flanges 7613 extending in parallel to the front face members.

The front face members 699 and the connecting bars 761 are manufactured by extrusion molding aluminum or aluminum alloy in the sectional shapes shown in FIGS. 26(g) and (f), cutting them at proper lengths, and post-processing assembly screw holes, etc. Thereafter, they are coupled together by means of fastening members.

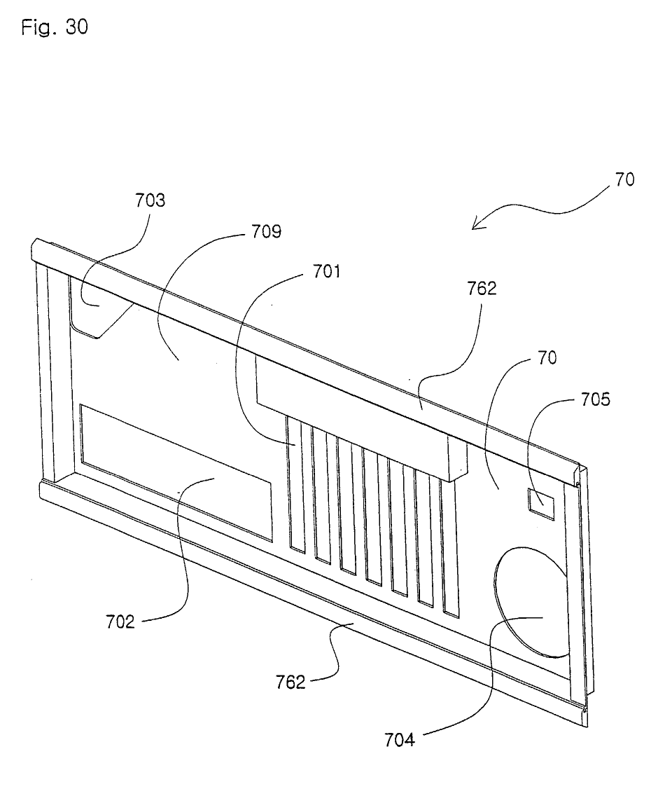

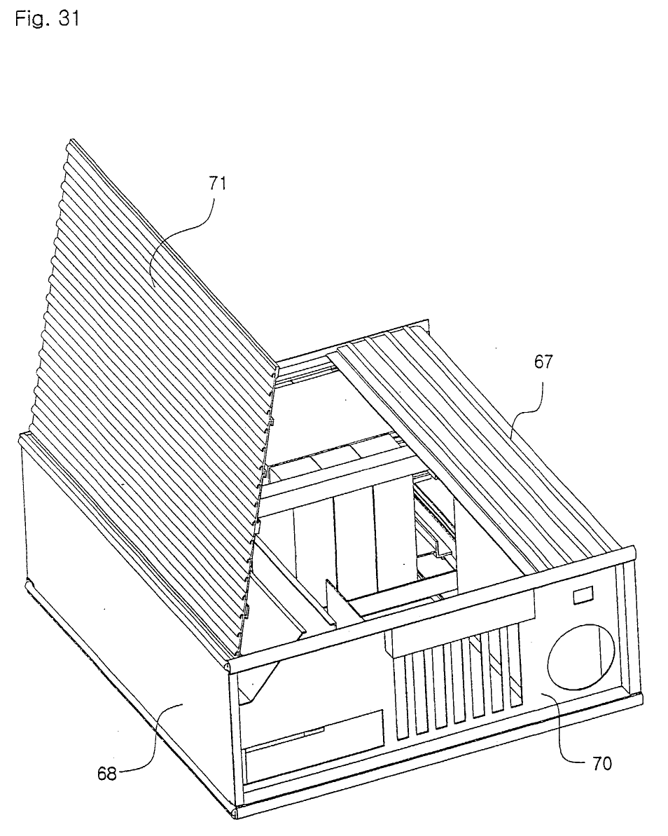

Referring to FIGS. 20 to 24 and 27 to 30, the rear panel 70 is assembled at the rear face of the case, and includes a rear face member 709 and connecting bars 762 for coupling with upper and lower ends of the rear face member. The rear face member 709 is provided with connection apertures 701 through which functional connectors of various card devices installed on the main board pursuant to the standard requirements of the main board are exposed to the exterior. The rear face member also has a connection aperture 702 allowing functional connectors installed directly on the main board to be exposed to the exterior. Further, an air-suction opening 703 and an air-outflow opening 704 are also provided therein. An airflow-guiding device 80 is fixed in the vicinity of the air suction opening 184. Although a cooling fan may be attached to the air-outflow opening 704, the present invention is not limited thereto. The cooling fan may also be installed in the airflow-guiding device 80, to be described later in detail.

The rear face member 709 is manufactured by press forming a metal sheet. At this time, various apertures are formed therein. The connecting bars 762 employ the same structure as the connecting bars 761 used for the front panel 69.

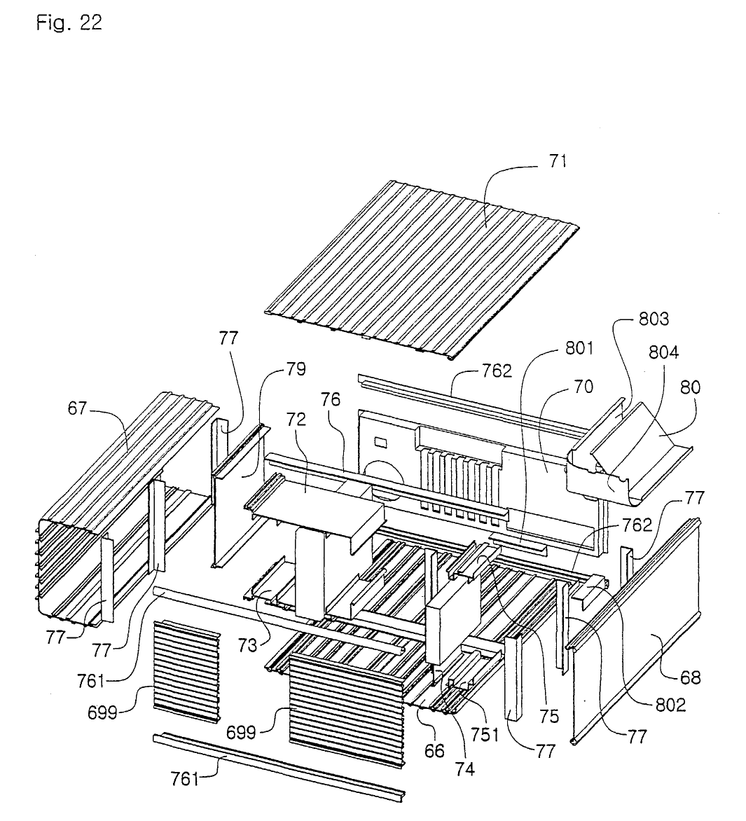

Referring to FIGS. 22. 23. 26(e), 31 and 32, the upper cover 71 is rotatably coupled with the right support 67. The upper cover 71 has a uniform shape in a section taken in the direction perpendicular to the lengthwise direction. The bottom surface of a flat plate of the first cover member is provided with protruding structures 711, 717, 712 to which screws are fastened or which are supported by the inner frame. The top surface of the plate of the cover is provided with a plurality of fins 716 for dissipating heat. A left end of the plate is placed on the stepped portion 679 of the left support 67. At this position, the cover 71 may be assembled to the left support 67 by fastening members such as screws or by using a locking device such as a clamp (not shown) capable of being selectively fastened or released.

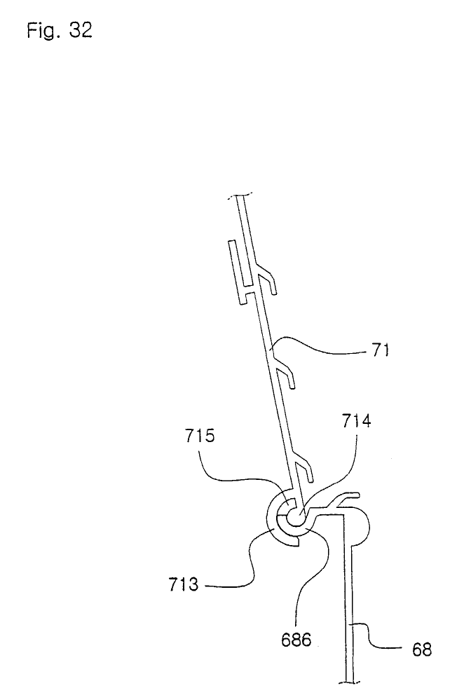

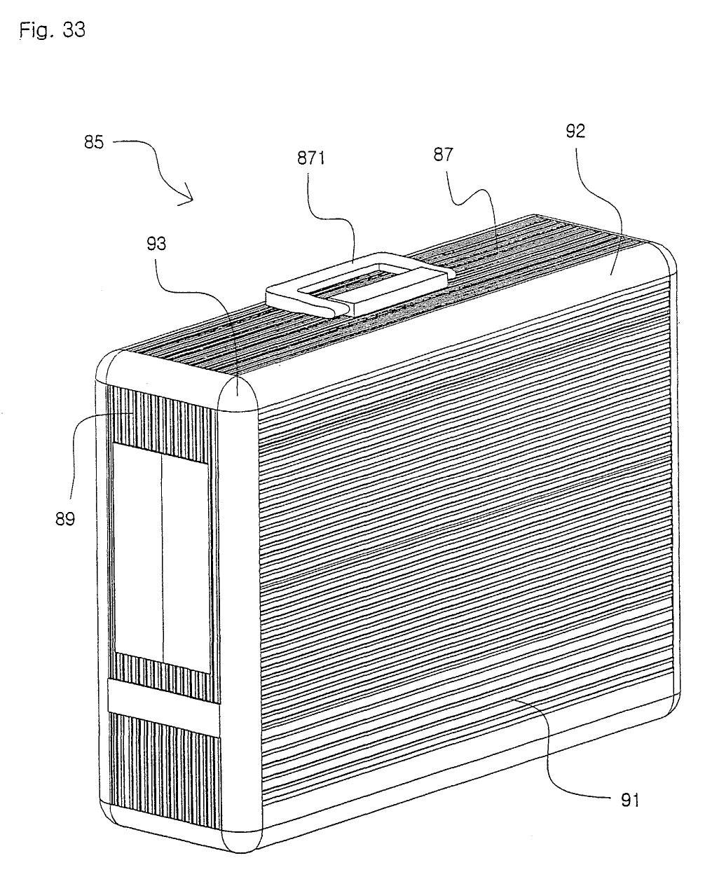

A right end of the plate of the cover is provided with a round rotating shaft 714 to be fitted into a central groove of the rotation supporting projection 686. In addition, the right end of the plate is provided with an arc-shaped inserting groove 715 surrounding the rotating shaft 714. An extension 713 for defining the inserting groove 715 is at the outside of the right end. As shown in FIG. 32, the rotation supporting projection 686 of the right support 68 is inserted into the inserting groove 715 so that it serves as a bearing. FIGS. 31 and 32 show the cover 71 in an opened state.

Referring to FIGS. 20 to 23 and 25, the mounting structure consists of two mounting structures 72, 73, 74, 75, 751 in a similar way to the second embodiment. These mounting structures 72, 73, 74, 75, 751 are extrusion molded to have a uniform shape in sections taken in a direction perpendicular to the lengthwise direction.

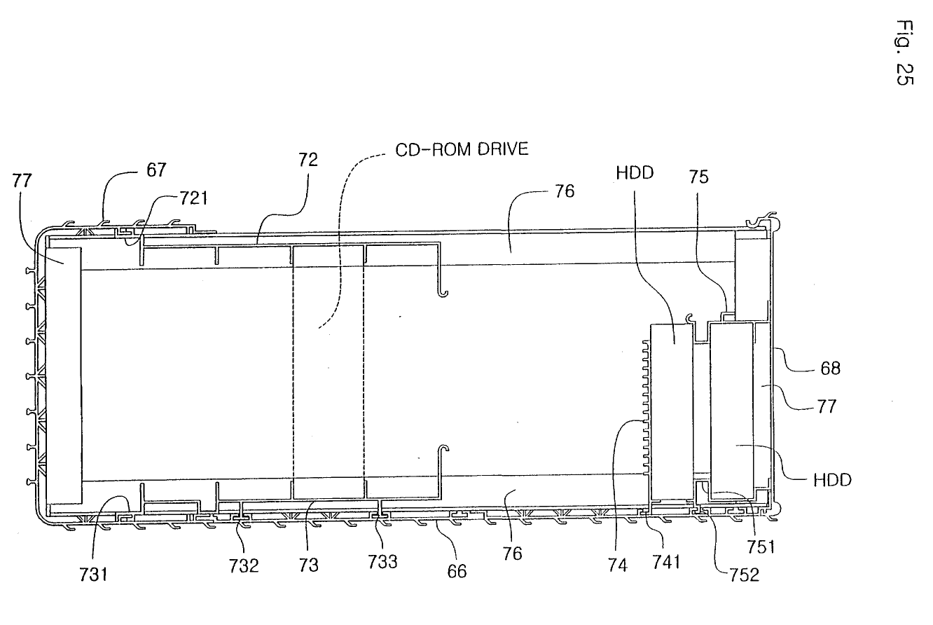

As shown in FIG. 25, the mounting structures 72, 73 include structures 721, 731 which are fitted into and coupled with the upper and lower wings 672, 673 of the left support 67, respectively. Furthermore, a space for accommodating the optical disk drive is formed by standing a wall at a proper position.

Moreover, the mounting structures 74, 75, 751 are secured on the base 66 or the right support 68. To this end, the mounting structures 74, 751 are provided with rib-shaped projections or coupling projections 741, 751 to be inserted into the rails. The mounting structure 75 is secured on the right support 68. These mounting structures 74, 75 751 are assembled together to provide a space for containing the HDD or FDD. Such mounting structures are not limited to those illustrated above, but may employ the mounting structure of the first or second embodiment or other mounting structures.

Referring to FIGS. 20 to 25, and 27 to 29, it is preferable that the computer case 65 be reinforced, by placing a plurality of crossbars 76 and vertical bars 76, 77 in the interior thereof. Particularly, it is more preferable that a supporting frame is formed therein by coupling the crossbars 76 with the vertical bars 77 at the center in the fore-and-aft direction. The lower crossbar 76 is secured on the bottom base 66. The vertical bars 76 are fixed to the left and right supports 67, 68, respectively. The base 66 and the left and right supports 67, 68 are securely coupled together by means of the frame.

Referring to FIGS. 20 to 23, 28 and 29, the airflow-guiding member 87 is installed above a cooling structure 81 of the CPU mounted on the main board 78. The airflow-guiding member 87 defines a passage through which air introduced via the air-suction opening 703 passes, and guides the air so that the sucked cool air first cools the CPU.

The airflow-guiding device 87 includes a first directing member 803 and a second directing member 804. The first directing member 803 has a uniform shape in a section taken in a direction perpendicular to the lengthwise direction. The first directing member 803 includes a bottom plate, a side wall and a partition 805 installed obliquely in the middle of the bottom plate. In the bottom plate of the first directing member 803, an aperture 806 is perforated toward the CPU cooling member. The second directing member 804 is positioned opposite to the air-suction opening. An edge of the second directing member is rounded to divert the airflow. The second directing member 804 is manufactured by injection molding plastic resin.

It is preferable to attach sound-absorbing materials to the bottom plate of the first directing member. In addition, a blowing fan may be attached to the bottom plate so that the air exits through the aperture 806 of the bottom plate. On the other hand, it is more preferable to install a filter at the air-suction opening 703 so that outside dust or the like is not introduced thereinto.

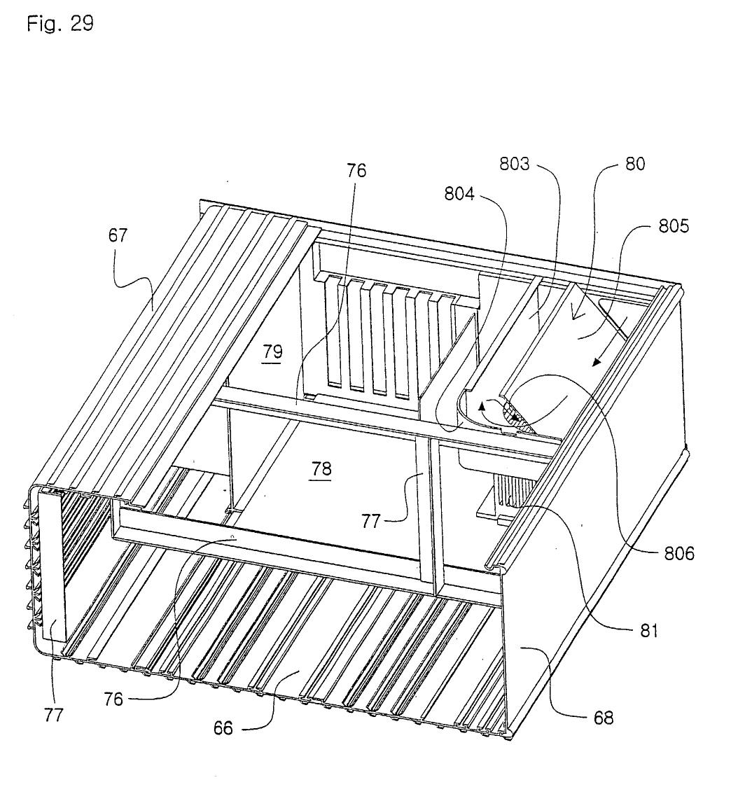

With such constitution, the air enters the air-suction opening 703, turns around the partition 805 and exits through the aperture 806 in the bottom plate, as designated by arrows in FIG. 29. In this way, the air flows toward the CPU to cool the CPU, passes through the interior of the computer, and is discharged via the power supply and the air-outflow opening 704 to the exterior.

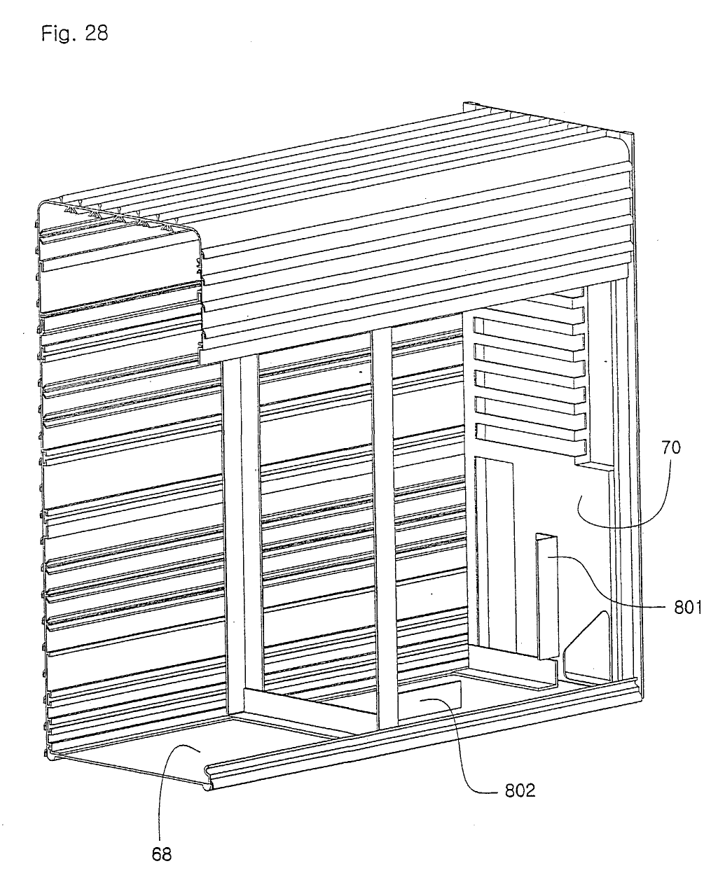

Referring to FIG. 28, supporting bars 801, 802 for mounting the airflow-guiding member 80 are fixed to the rear panel 70 and the right support 68. The airflow-guiding member 80 is placed on and fixed to the supporting bars 801, 802.

Fourth Embodiment

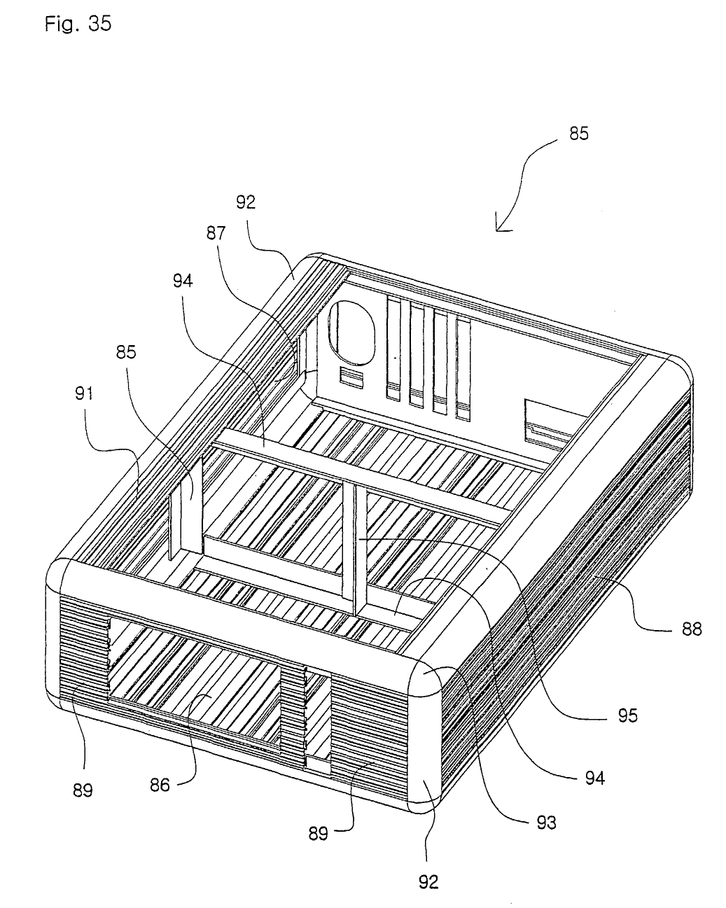

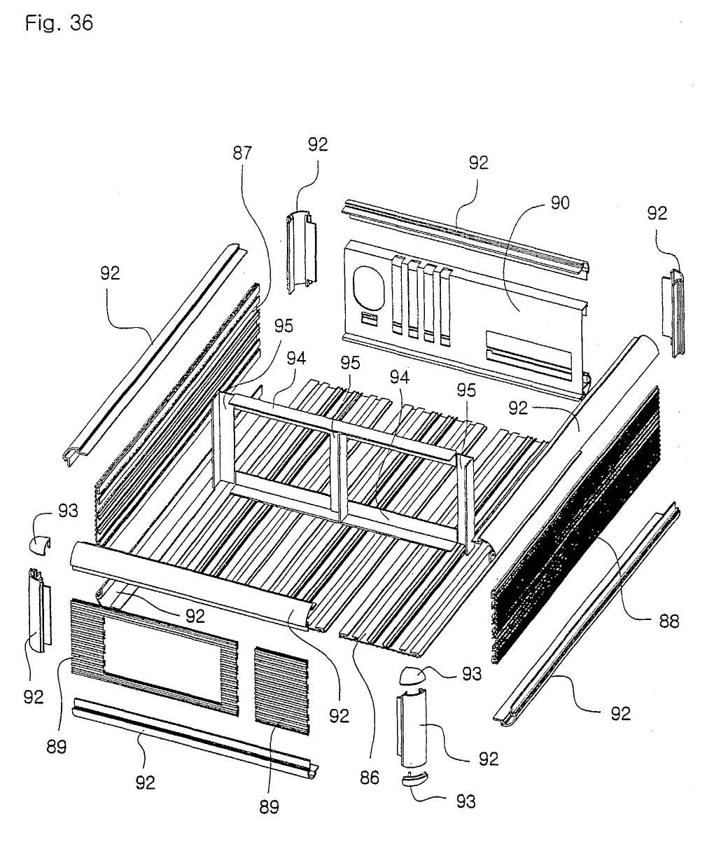

A computer case according to a fourth embodiment of the present invention is conceived with special consideration to the mobility of the case. The computer case is comprised of structural parts made by combining extrusion molded parts with an identical shape. Referring to FIGS. 33 to 40, the computer case 85 includes a bottom base 86, a left support 87, a right support 88, a front panel 89, a rear panel 90, and an upper cover 91. Edge members 92 are interposed between these members in order to connect them together. Corner members 93 are assembled at corner portions. Storage devices such as a CD-ROM, a HDD and a FDD are mounted in the interior of the case, and a main board, circuit card devices, a power supply etc. are installed in the rear of the case. The inner space of the case is partitioned by a frame comprised of crossbars 94 and vertical bars 95, in the same way as the second and third embodiments.

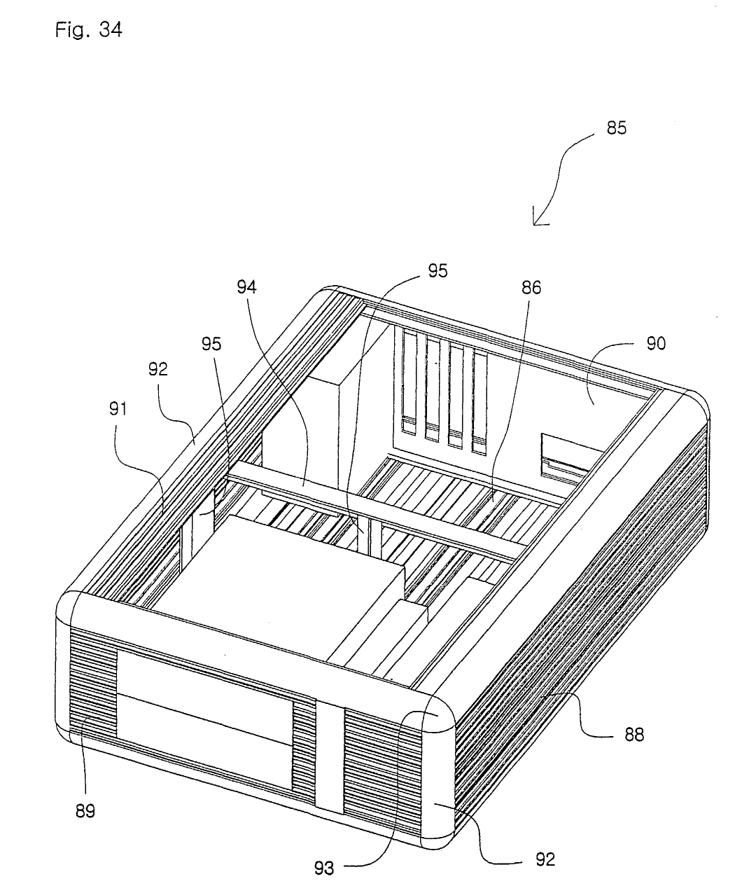

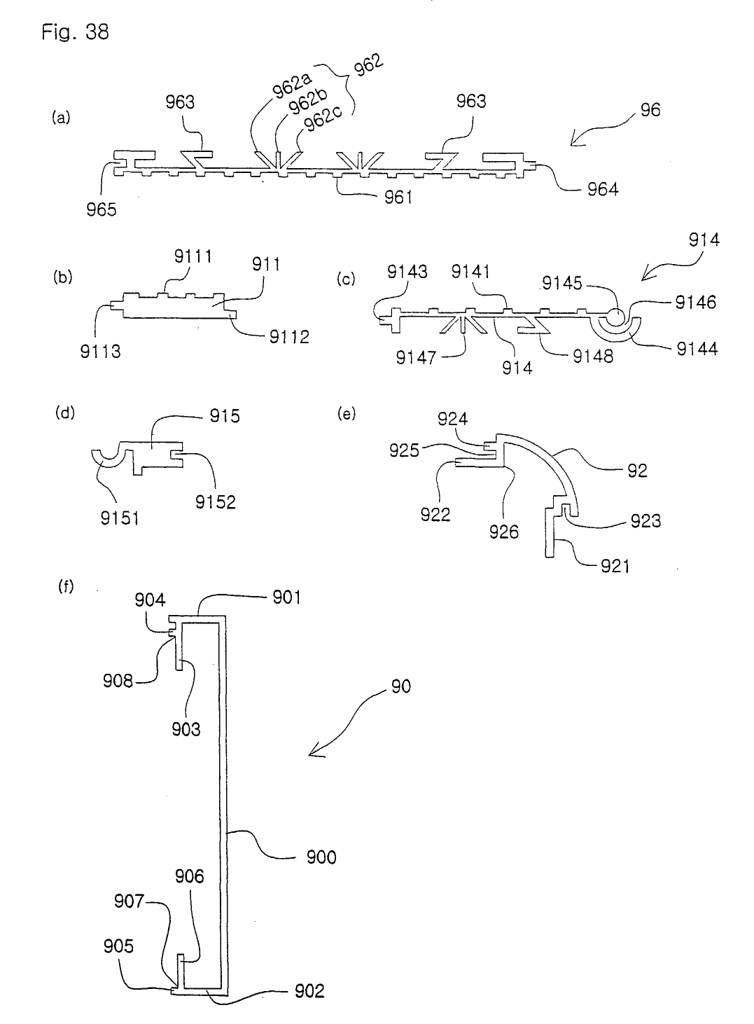

A bottom base 86 will be described with reference to FIGS. 34 to 37 and 38(a). The base 86 consists of base members 861, 862, 863. These base members have an identical shape and employ a plate member 96 shown in FIG. 38(a). The plate member 96 is a common member used for the base, the left and right supports, the cover, the front panel, etc.

One side of the plate member 96 is provided with a noise-reducing rib structures 962 which was explained with respect to the third embodiment. Fixing rib structures 963 extend obliquely from the plate portion 961, are bent and extend again in a horizontal direction (direction parallel to the plate portion). A left end of the plate member 96 is provided with a coupling groove 965, and a right end thereof is provided with a coupling projection 964.

This plate member 96 is manufactured by extrusion molding a metal such as aluminum and has a uniform shape in a section taken in a direction perpendicular to the lengthwise direction. The base 86 is obtained by assembling three plate members.

Referring to FIGS. 33 to 38, the left and right supports 87, 88 and the front panel 89 employ the plate member 96 as it is. However, the left support 87 is further provided with a handle 871. The front panel 89 is further provided with an aperture through which devices in the case are exposed.

Referring to FIGS. 34 to 36, 38(f) and 40, the rear panel 90 is assembled at the rear face of the case, and includes a back plate 900 and wings 901, 902 at upper and lower ends of the back plate. The upper wing 901 includes an extension 903 which extends rearward from the back plate 900 and is bent to extend downwardly again. The extension 903 has a nook 908 defined by a projection 904. The lower wing 902 has an upwardly extending extension 906 and a nook 907 defined by a projection 905, in the same way as the upper wing. Edge portions 926 placed at second wings 922 of the edge members are positioned at the nooks 908, 906 (see FIG. 38(e)).

The back plate has connection apertures through which functional connectors of various card devices installed on the main board pursuant to the standard requirements of the main board are exposed to the exterior. It also has a connection aperture allowing functional connectors installed directly on the main board to be exposed to the exterior, and an air passage.

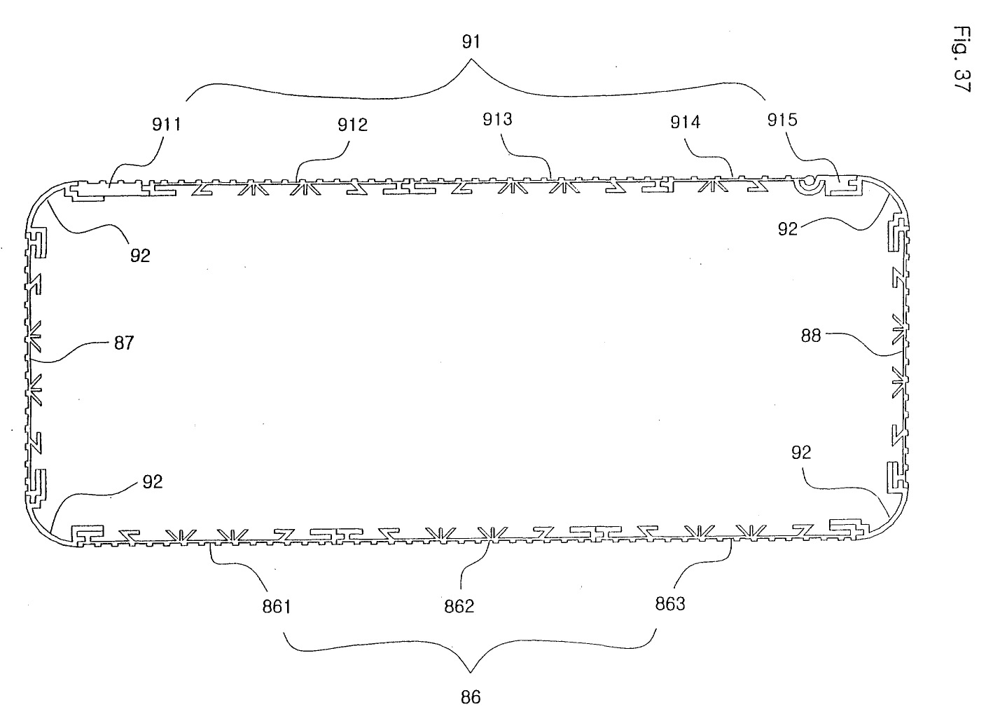

Referring to FIG. 37, the upper cover 91 is constructed by connecting a first cover member 911, second and third cover members 912, 913, a fourth cover member 914 and a fifth cover member 915 in sequence. Here, the second and third cover members 912, 913 employ the plate member 96 of the common part as it is. The first cover member 911 is coupled with the edge members. To this end, a left end of the first cover member is provided with a coupling projection 9113. An outer surface of the first cover member is formed with fins 9111. A right end thereof is provided with a stepped portion 9112. A left end of the second cover member 912 is placed on the stepped portion 9112.

The fourth cover member 914 has a noise-reducing rib structure 9147 and a fixing rib structure 9148. An outer surface of the fourth cover member is formed with heat-dissipating projections 9141. A left end thereof is provided with a projection 9143 for coupling with the plate member 96. The description of hinge portions 9144, 9145, 9146 will be omitted since they are identical with those of the second embodiment.

A right end of the fifth cover member 915 is provided with a coupling groove 9152. A left end thereof is formed with a hinge portion 9156 of which description will be omitted since it is identical with that of the second embodiment.

The first cover member 911 is fixed to the left edge member, and the fifth cover member 915 is fixed to the right edge member 92. The second, third and fourth cover members 912, 913, 914 are coupled together and then assembled to the fifth cover member 915 via the hinge. The second cover member 915 is detachably connected to the first cover member 911 by the use of screws or clamps (not shown).

Referring to FIG. 38(e), the edge member 92, commonly used for all the edges of the computer case 85, includes wing portions 921, 922 which extend from the rounded body while forming an angle of 90 degrees therebetween. Each of the wing portions 921, 922 consists of a first extension protruding from the arc-shaped body toward the center of the arc of the body, and a second extension bent perpendicularly to and extending from the first extension. The first extension of the first wing portion 921 has a coupling groove 923 at a position inward from an outer surface of the arc-shaped body. The first extension of the second wing portion 922 is provided with a coupling projection 924 at a position inward from the outer surface of the arc-shaped body. Thus, a coupling groove 925 is naturally formed between the coupling projection 924 and the second extension. The edge member is manufactured by extrusion molding a metal such as aluminum.

As for the coupling of the edge member 92 and the other members, the plate member 96 will be explained by way of example. The coupling projection 964 at the end of the plate member 96 is fitted into the coupling groove 923 in the first wing portion 921 of the edge member 92. The coupling projection 924 in the second wing portion 922 is fitted into the coupling groove 965 at the end of the plate member 924.

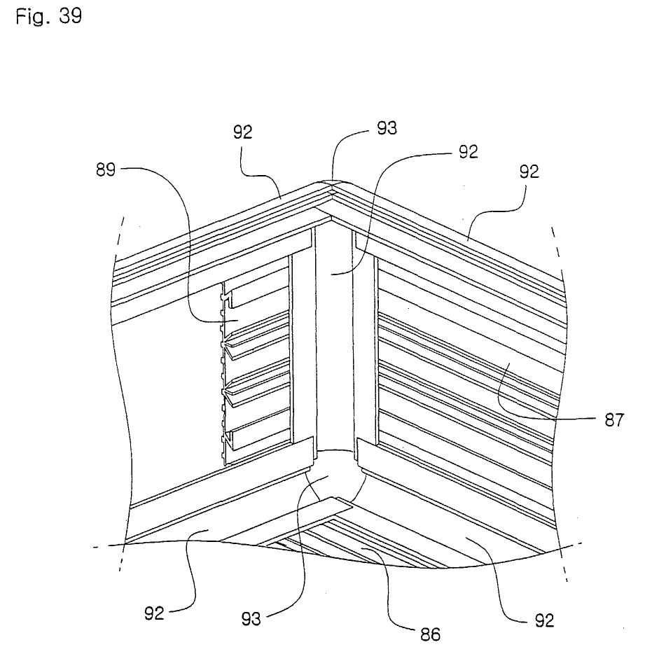

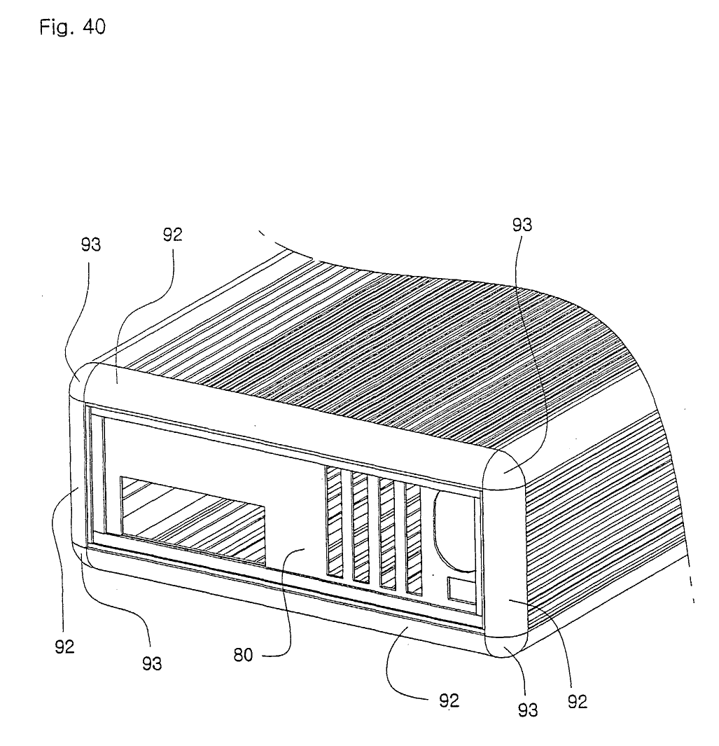

A person having an ordinary skill in the art could easily couple the respective edge members 92 with the bottom base 86, the left support 87, the right support 88, the front and rear panels 89, 90, and upper cover, with reference to the above descriptions and the accompanying drawings (in particular, FIGS. 39 and 40). Furthermore, the aforementioned person could easily install built-in hardware devices in the computer case according to the fourth embodiment with reference to the first to third embodiments.

The computer case according to the fourth embodiment constructed as such is compact and has excellent mobility. In addition, since there are a lot of common parts, the number of parts is reduced.

Although the exemplified embodiments of the present invention have been shown and described by way of examples, it should be understood that various changes, modifications or addition thereto may be made without departing from the spirit and scope of the present invention.

1. A computer case for accommodating hardware devices of a computer including a circuit board, comprising:
a bottom base constructed to have a substantially uniform sectional shape, and having a fixing rail integrally formed on the top thereof for placing the circuit board;
a first support disposed at one side of said bottom base and constructed to have a substantially uniform sectional shape;
a second support disposed at the other side of said bottom base and constructed to have a substantially uniform sectional shape;
a front panel disposed in the front of said bottom base;
a rear panel disposed in the rear of said bottom base; and
an upper cover facing said bottom base and covering the top of the computer.

2. The computer case as claimed in claim 1, wherein said bottom base and said first and second supports are formed unitarily.

3. The computer case as claimed in claim 1 or 2, wherein said front panel has a substantially uniform sectional shape.

4. The computer case as maimed in claim 1 or 2, wherein said rear panel has a substantially uniform sectional shape.

5. The computer case as claimed in claim 1 or 2, wherein said cover has a substantially uniform sectional shape.

6. The computer case as claimed in any one of claims 1 to 5, wherein edge members are interposed between and connected to at least two adjoining structures of said base, said supports, said panels and said cover, and each of said edge members has a substantially uniform sectional shape.

7. The computer case as claimed in claim 1, wherein said fixing rail extends in the fore-and-aft direction thereof, and has a sectional shape of protruding upwardly and extending in a horizontal direction.

8. The computer case as claimed in claim 1, wherein said fixing rail extends in the fore-and-aft direction thereof, and includes a pair of ribs, and the ribs have a sectional shape of protruding upwardly and extending in a horizontal direction toward each other, respectively.

9. The computer case as claimed in claim 1, wherein at least one structure of said base, said supports, said panels and said cover is provided with a rib structure including a plurality of ribs radially protruding therefrom.

10. The computer case as claimed in claim 1, wherein at least one structure of said base, said supports, said panels and said cover is provided with a plurality of fins protruding from an outer surface thereof and arranged side by side.

11. The computer case as claimed in claim 1, wherein at least two structures of said base, said supports, said panels and said cover are comprised of one or more plate member having a substantially uniform sectional shape.

12. The computer case as claimed in claim 1, wherein said base is constructed by coupling two more plate-shaped members, each of which has a substantially uniform sectional shape.

13. The computer case as claimed in claim 1, wherein the entire cover or some portions of said cover is provided with a hinge at one end thereof so that said entire cover or some portions of said cover can be opened by rotating about said hinge.

14. The computer case as claimed in claim 13, wherein said hinge provided at said entire cover or some portions of said cover includes a rotating shaft having a circular cross-section and an inserting groove formed in the shape of arc around said rotating shaft, and said inserting groove contains a supporting projection in the shape of arc provided on a structure of said case relatively fixed with respect to said entire cover or some portions of said cover.

15. The computer case as claimed in claim 1, wherein a CPU and a cooling member for cooling said CPU are installed on said main board for said computer and said rear panel is provided with an air-suction opening, and further comprising an airflow-guiding member positioned above said CPU cooling member and guiding an airflow from said air-suction opening toward the top of said CPU cooling member.

16. The computer case as claimed in claim 1, wherein said airflow-guiding member has a substantially uniform sectional shape, the bottom of said airflow-guiding member is secured on said CPU cooling member in contact therewith, and the top of said airflow-guiding member is provided with a plurality of heat-dissipating fins arranged side by side.

17. The computer case as claimed in claim 1, further comprising a mounting structure for installing hardware devices such as storage devices for said computer, said mounting structure having a substantially uniform sectional shape.

18. The computer case as claimed in claim 1, further comprising a hinge device coupled with a display device integrally incorporated into said computer so as to provide rotation of said display device.

19. The computer case as claimed in claim 18, wherein said hinge device includes a first hinge allowing rotation by which said display device is collapsible, and a second hinge allowing rotation by which said display device can revolve on its axis.

20. The computer case as claimed in claim 19, wherein said second hinge is provided with a stopper for preventing said rotation beyond the predetermined number of rotation.

21. The computer case as claimed in claim 1, wherein at least one of said side supports is provided with a carrying handle.
